(19) United States
(12) Patent Application Publication
(10) Pub. No.: US 2026/0356485 A1
(43) Pub. Date: Nov. 12, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US)

(21) Appl. No.: 19/444,566

(22) Filed: Jan. 9, 2026

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64D 27/18; B64D 27/40

(52) U.S. Cl. CPC B64D 27/18; B64D 27/402

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATIONS

This application is a continuation-in-part of International Appl. No. PCT/US2024/040754, filed Aug. 2, 2024, which claims priority to U.S. patent application Ser. No. 18/230,609 (now U.S. Pat. No. 12,365,471), filed on Aug. 4, 2023, and U.S. patent application Ser. No. 18/652,052 (now U.S. Pat. No. 12,384,522), filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle Φ for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers;

FIG. 11 comprises a schematic representation showing exemplary locations of a point P of one of the unducted fan propulsors, as defined herein, within the first ellipse, the second ellipse, the third ellipse, and the fourth ellipse;

FIG. 12 is a schematic cross-sectional view of the unducted fan propulsor of FIG. 3 according to an exemplary embodiment of the present subject matter;

FIG. 13 is a perspective view of a portion of an aircraft having an unducted fan propulsor according to an exemplary embodiment of the present subject matter;

FIG. 14 is a side view of the aircraft of FIG. 13 according to an exemplary embodiment of the present subject matter;

FIG. 15 is a top view of an exemplary aircraft according to an exemplary embodiment of the present subject matter;

FIG. 16 is a side perspective view of an open rotor pylon system including a pylon fairing according to another exemplary embodiment of the present subject matter;

FIG. 17 is a cross-section view of a first chord (CUT A) of a pylon fairing at a first position, and a second chord (CUT B) of a pylon fairing at a second position, with the first chord and the second chord in an overlapping configuration according to another exemplary embodiment of the present subject matter;

FIG. 18 is a cross-section view of a first chord (CUT A) of a pylon fairing at a first position, and a second chord (CUT B) of a pylon fairing at a second position, with the first chord and the second chord shown separated according to another exemplary embodiment of the present subject matter;

FIG. 19 is a perspective view of an open rotor pylon system including a pylon fairing according to another exemplary embodiment of the present subject matter;

FIG. 20A is a side elevation view of a pylon fairing according to another exemplary embodiment of the present subject matter;

FIG. 20B is a cross-section view of the pylon fairing of FIG. 20A, taken along line 20B-20B of FIG. 20A, according to another exemplary embodiment of the present subject matter;

FIG. 21A is a cross-section view of a first pylon fairing and a cross-section view of a second pylon fairing according to another exemplary embodiment of the present subject matter;

FIG. 21B is a cross-section view of a first pylon fairing and a cross-section view of a second pylon fairing according to yet another exemplary embodiment of the present subject matter;

FIG. 22 is a perspective view of an open rotor pylon system including a pylon fairing according to another exemplary embodiment of the present subject matter;

FIG. 23 is a side elevation view of an open rotor pylon system including a pylon fairing according to another exemplary embodiment of the present subject matter;

FIG. 24 is a schematic view of an open rotor pylon system including a pylon fairing according to another exemplary embodiment of the present subject matter;

FIG. 25 is a schematic view of an open rotor pylon system including a pylon fairing according to another exemplary embodiment of the present subject matter;

FIG. 26 is another schematic view of an open rotor pylon system including a pylon fairing according to another exemplary embodiment of the present subject matter;

FIG. 27 is a cross-section view of an open rotor pylon system including a pylon fairing according to another exemplary embodiment of the present subject matter;

FIG. 28 is a schematic view of a leading edge section of a pylon fairing according to another exemplary embodiment of the present subject matter;

FIG. 29 is a side perspective view of an open rotor pylon system including a pylon fairing according to another exemplary embodiment of the present subject matter;

FIG. 30A is a cross-sectional view taken along line A-A of FIG. 29 of a first portion of a pylon fairing at a first position according to another exemplary embodiment of the present subject matter;

FIG. 30B is a cross-sectional view taken along line B-B of FIG. 29 of a second portion of a pylon fairing at a second position according to another exemplary embodiment of the present subject matter;

FIG. 30C is a cross-sectional view taken along line C-C of FIG. 29 of a third portion of a pylon fairing at a third position according to another exemplary embodiment of the present subject matter;

FIG. 31 is another schematic view of an open rotor pylon system including a pylon fairing according to another exemplary embodiment of the present subject matter;

FIG. 32 is a schematic view of an engine having an aft fuselage installation according to another exemplary embodiment of the present subject matter;

FIG. 33 is a schematic side view of the unducted fan propulsor of FIG. 3 attached to a wing in accordance with one or more embodiments of the present disclosure;

FIG. 34 is a schematic cross-sectional aft view of the unducted fan propulsor of FIG. 3 attached to a wing according to one or more embodiments of the present disclosure;

FIG. 35 is a schematic cross-sectional aft view of the unducted fan propulsor of FIG. 3 attached to a wing according to one or more embodiments of the present disclosure;

FIG. 36 is an explanatory view of a flat section of the fan cowl or nacelle to the right of the pylon fairing in FIG. 35 compared with a conventional fan nacelle;

FIG. 37 is a schematic cross-sectional aft view of the unducted fan propulsor of FIG. 3 attached to a wing according to one or more embodiments of the present disclosure;

FIG. 38 is a schematic side view of the unducted fan propulsor of FIG. 3 attached to a wing in accordance with one or more embodiments of the present disclosure; and

FIG. 39 is a graphical representation of a gully area for a given axial station of a gas turbine engine in accordance with one or more embodiments of the present disclosure.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

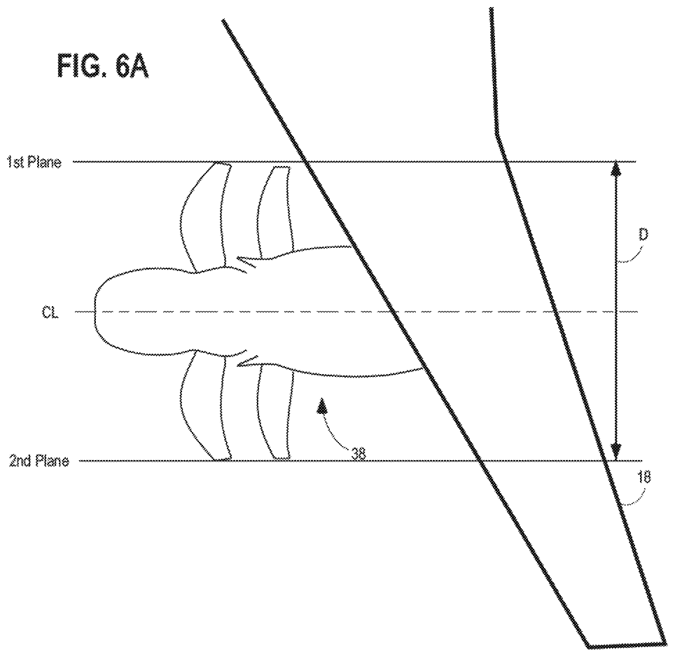

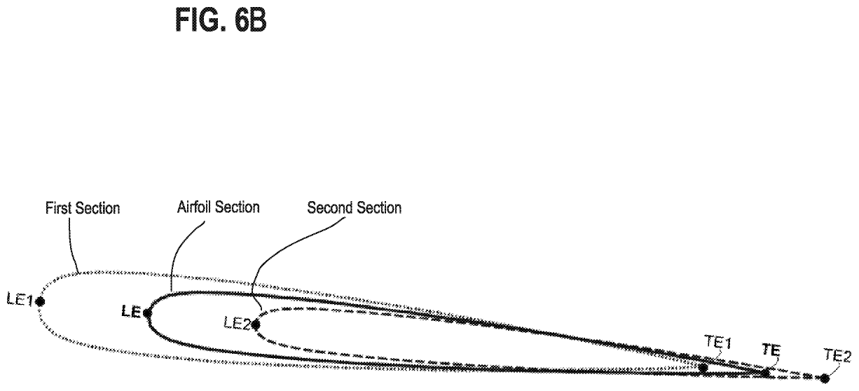

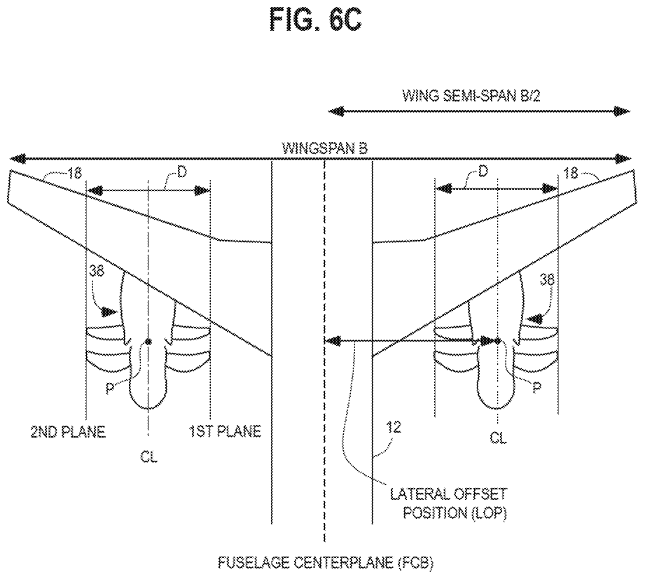

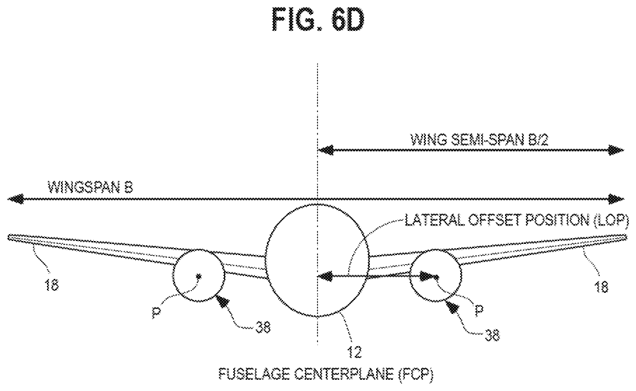

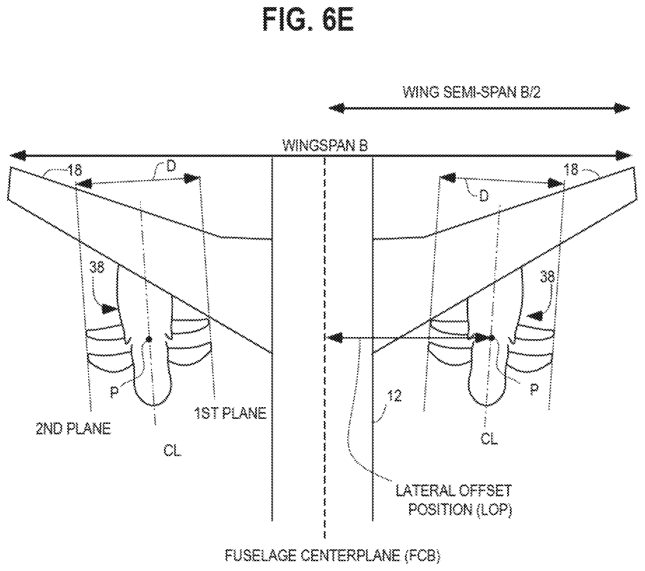

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section. Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

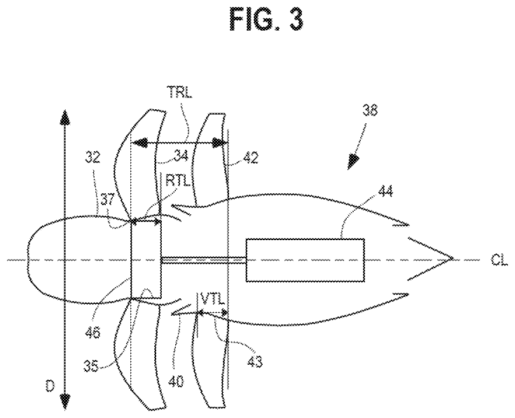

“Unducted fan propulsor” as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output guide vanes (OGV) or input guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

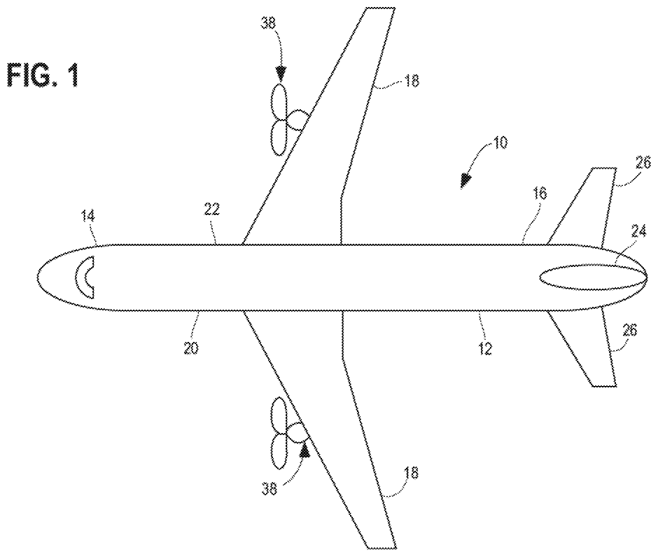

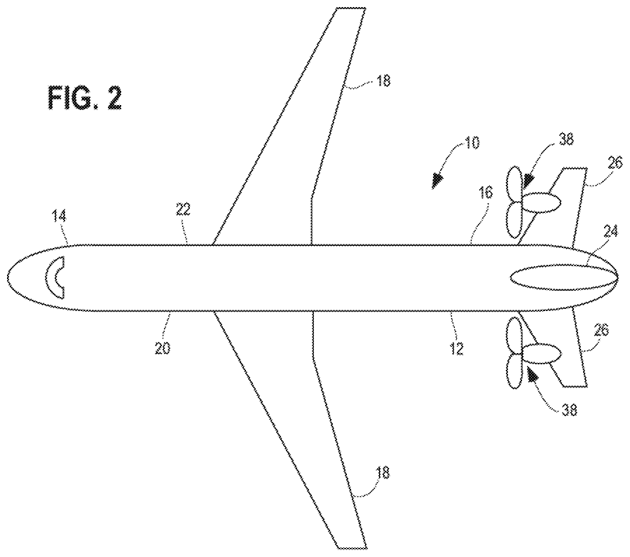

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 disposed around CL.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

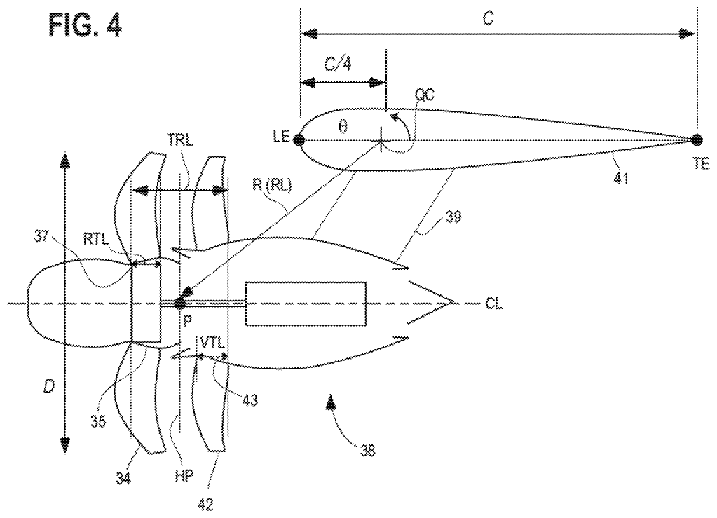

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIGS. 3, 4, and 5A. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

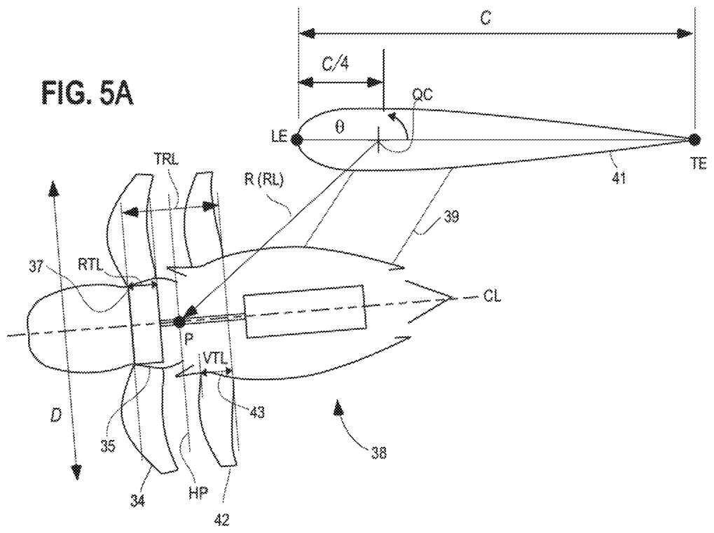

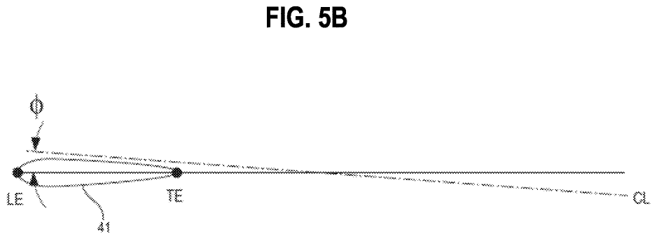

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle Φ for the propulsor 38, which is the angle spanned between the propulsor centerline CL and chord line C. Positive pitch corresponds to a clockwise rotation of CL relative to C. The pitch angle Φ can be fixed or variable during flight. For underwing installations, the pitch angle Φ can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle Φ can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

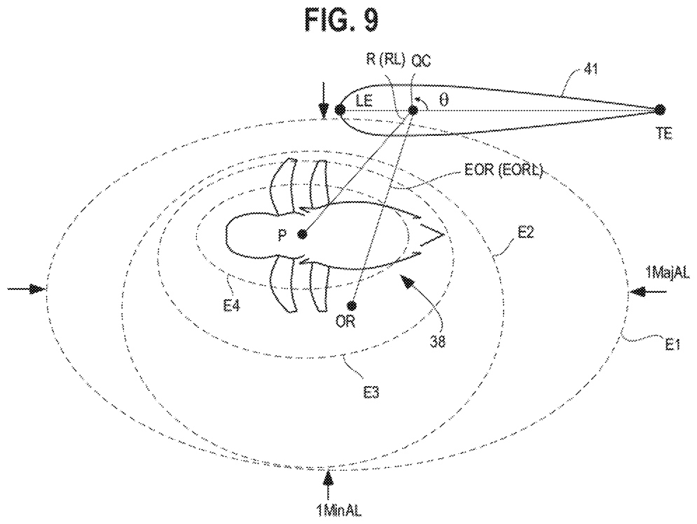

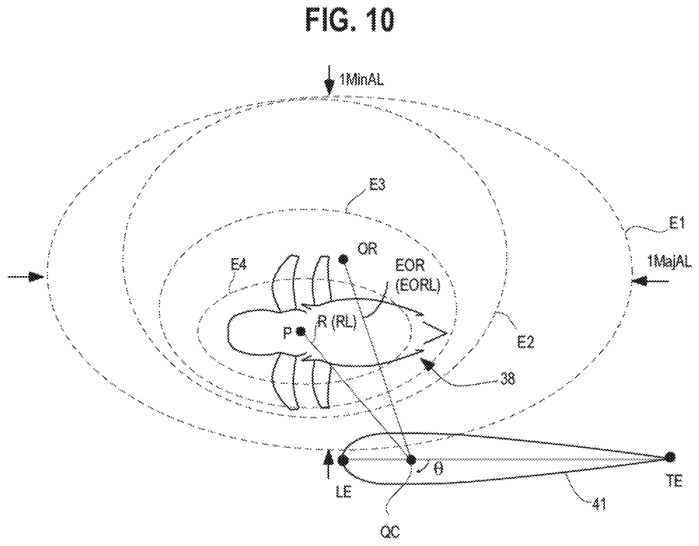

The angle θ is measured relative to a datum that is the airfoil section chord line (e.g., in FIG. 4 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

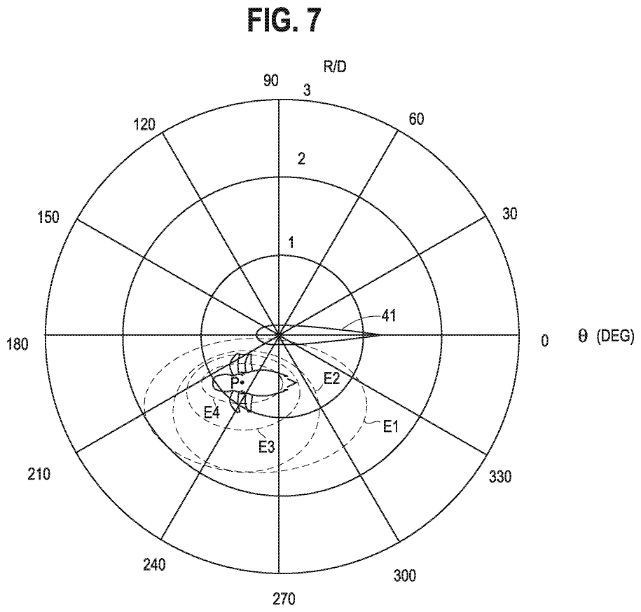

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/D is 2.8 and 1MinAL/D is 1.7. A unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. A unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/D is 1.4 and 3MinAL/D is 0.9. A unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. A unducted fan propulsor located within E4 tends to offset scrubbing and interference drag.

The location of the unducted fan propulsor system (i.e., point P) relative to the airfoil section may also be expressed in terms of the following expressions:

$$\frac{R L}{D} + \frac{( \sqrt{a * [ b * {sin}^{2} ( θ ) - c * c o {s}^{2} ( θ ) + d * sin ( θ ) * cos ( θ ) ]} + e * sin ( θ ) + f * cos ( θ ) )}{g * s i {n}^{2} ( θ ) + h * c o {s}^{2} ( θ )} > 0$$

$$and$$

$$\frac{R L}{D} + \frac{( - \sqrt{a * [ b * {sin}^{2} ( θ ) - c * {cos}^{2} ( θ ) + d * sin ( θ ) * cos ( θ ) ]} + e * sin ( θ ) + f * cos ( θ ) )}{g * {sin}^{2} ( θ ) + h * {cos}^{2} ( θ )} < 0$$

where 0.07<RL/D<1.98 and θ is between 187° and 340°, and where a, b, c, d, e, f, g and h have the values set forth in the following table under the heading “Fifth Emb.”:

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and θ is between 199° and 306°, and where a, b, c, d, e, f, g and h have the values set forth in the above table under the heading “Sixth Emb.”

In a seventh embodiment, the point P of the unducted fan propulsor 38 can be defined by the above expression, but where 0.369<RL/D<1.43 and θ is between 204° and 291°, and where a, b, c, d, e, f, g and h have the values set forth in the above table under the heading “Seventh Emb.”.

In an eighth embodiment, the point P of the unducted fan propulsor 38 can be defined by the above expression, but where 0.477<RL/D<0.9455 and θ is between 211° and 274°, And where a, b, c, d, e, f, g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

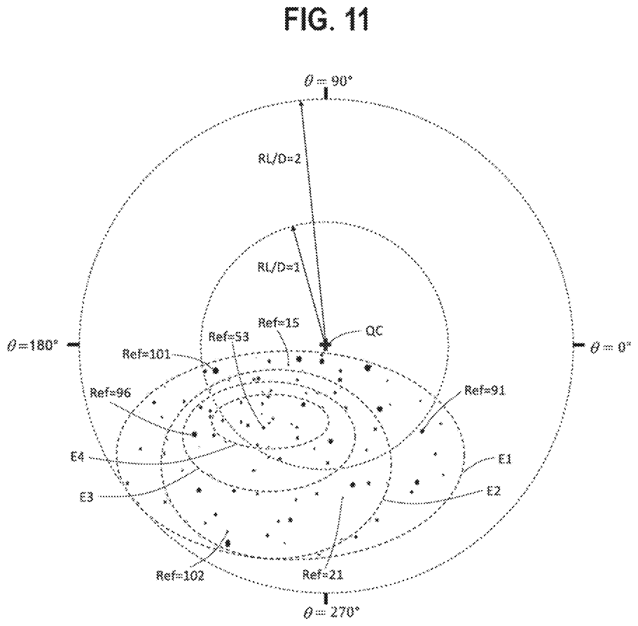

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref.” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to airfoil section quarter chord point

| | Type of | | | | |
|---|---|---|---|---|---|
| Ref. | aircraft | RL | D | θ (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator for | |
|---|---|
| TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| | | EORL | 1MajAL | 1MinAL | | | |
|---|---|---|---|---|---|---|---|
| D (ft) | θ (deg) | (ft) | (ft) | (ft) | EORL/D | 1MajAL/D | 1MinAL/D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| | | EORL | 2MajAL | 2MinA | | | |
|---|---|---|---|---|---|---|---|
| D (ft) | θ (deg) | (ft) | (ft) | L (ft) | EORL/D | 2MajAL/D | 2MinAL/D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| | | | 3MajAL | 3MinAL | | | |
|---|---|---|---|---|---|---|---|
| D (ft) | θ (deg) | EORL (ft) | (ft) | (ft) | EORL/D | 3MajAL/D | 3MinAL/D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| | | EORL | 4MajAL | 4MinAL | | | |
|---|---|---|---|---|---|---|---|
| D (ft) | θ (deg) | (ft) | (ft) | (ft) | EORL/D | 4MajAL/D | 4MinAL/D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

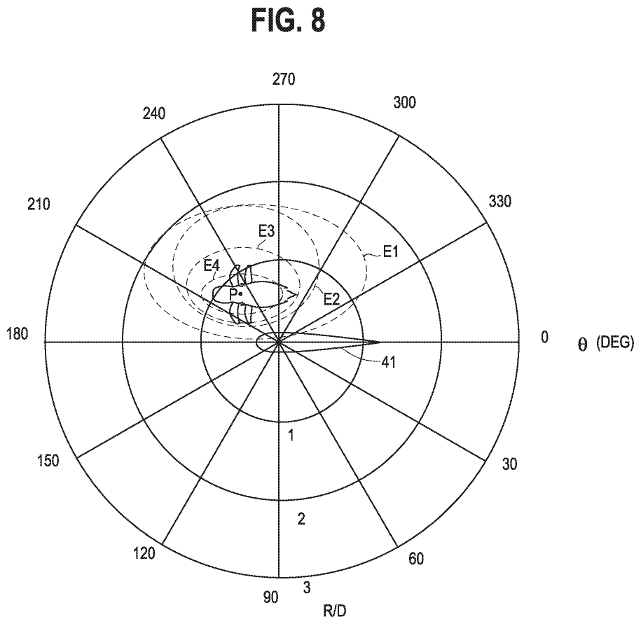

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach>1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{n e t}}{{ρ}_{0} {A}_{a n} {V}_{0}^{2}}$$

In the above thrust parameter, Fₙₑₜ is cruise fan net thrust, ρ₀ is ambient air density, Vₒ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0.15 > \frac{{F}_{net}}{{ρ}_{0} {A}_{a n} {V}_{0}^{2}} > 0.06$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to thereby offset drag penalties resulting from the installation of unducted fan propulsors.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

As disclosed above, the inventors determined certain criteria for positioning an unducted fan propulsor relative to an aircraft wing that reduces drag and, thus, improves thrust efficiency without increasing the required engine power. To further improve thrust efficiency, disclosed herein are aerodynamically designed pylon fairings. Open fan installations uniquely have fan stream exhaust washing a pylon fairing that connects the engine to the aircraft. Traditional turbofans only have a freestream flow scrubbing the pylon fairing and such a flow does not have swirl. An open fan's exhaust scrubs the pylon fairing with a swirling flow of higher velocity than such a freestream flow. This results in a greater risk of higher drag and a loss of efficiency. The aerodynamically designed pylon fairings described below help to mitigate (e.g., reduce) swirl losses from the air exiting the fan (or the outlet guide vanes). In particular, the pylon fairings described below are optimized, within the criteria of the engine placement (disclosed above) and exit fan swirl, to reduce shockwave losses, aerodynamic pressure drag, and surface friction drag. This promotes a more robust wing aero-swirl recovery from the fan. Therefore, the example pylon fairings disclosed herein can be used to further improve thrust delivered to an aircraft without increasing required engine power. Also, the aerodynamic shape of the example pylon fairings results in reduced noise.

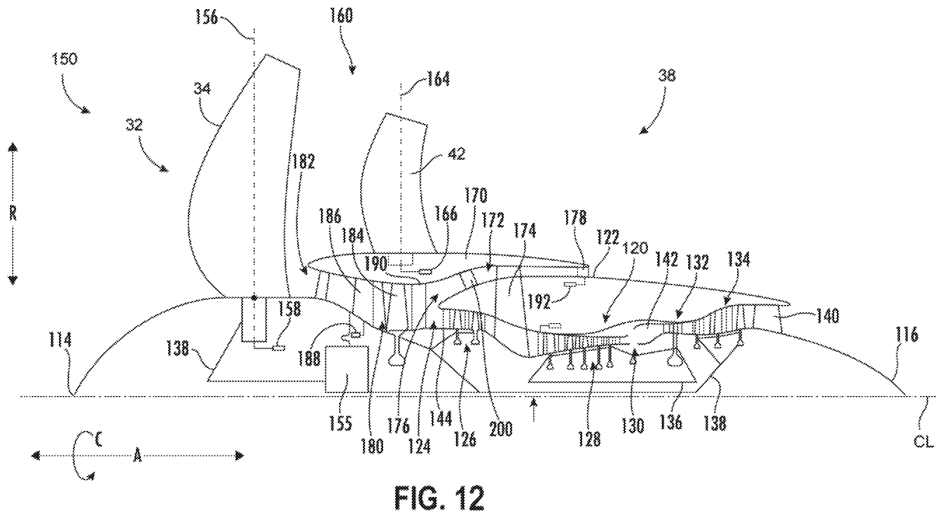

FIG. 12 is a schematic cross-sectional view of the exemplary unducted fan propulsor 38. Certain example features are described in connection with the unducted fan propulsor 38, but it understood that such features can likewise be implemented with any of the unducted fan propulsors disclosed herein. The unducted fan propulsor of FIG. 12 includes a third stream extending from the compressor section to a rotor assembly flowpath over the turbomachine, as will be explained in more detail below. As used herein, the term “first stream” or “free stream” refers to a stream that flows outside of the engine inlet and over a fan, which is unducted. Furthermore, the first stream is a stream of air that is free stream air. As used herein, the term “second stream” or “core stream” refers to a stream that flows through the engine inlet and the ducted fan and also travels through the core inlet and the core duct. As used herein, the term “third stream” or “mid-fan stream” refers to a stream that flows through an engine inlet and a ducted fan but does not travel through a core inlet and a core duct. Furthermore, the third stream is a stream of air that takes inlet air as opposed to free stream air. The third stream goes through at least one stage of the turbomachine, e.g., the ducted fan.

For reference, the unducted fan propulsor 38 defines an axial direction A, a radial direction R, and a circumferential direction C. In general, the axial direction A extends parallel to the centerline (CL), the radial direction R extends outward from and inward to the centerline (CL) in a direction orthogonal to the axial direction A, and the circumferential direction extends three hundred sixty degrees (360°) around the centerline (CL). The unducted fan propulsor 38 extends between a forward end 114 and an aft end 116, e.g., along the axial direction A.

The unducted fan propulsor 38 includes a turbomachine 120 and a rotor assembly, also referred to a fan section 150, positioned upstream thereof. The turbomachine 120 corresponds to the drive mechanism 44 and may be implemented as a gas turbine engine. Generally, the turbomachine 120 includes, in serial flow order, a compressor section, a combustion section, a turbine section, and an exhaust section. Particularly, as shown in FIG. 12, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 128 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan, which is implemented by the propeller assembly 32 having the array of blades 34. The blades 34 are rotatable, e.g., about the centerline (CL). As noted above, the propeller assembly 32 is drivingly coupled with the low pressure turbine 134 via the LP shaft 138. For the embodiments shown in FIG. 12, the propeller assembly 32 is coupled with the LP shaft 138 via a speed reduction gearbox 155, e.g., in an indirect-drive or geared-drive configuration.

Moreover, the array of blades 34 can be arranged in equal spacing around the centerline (CL). Each blade 34 has a root and a tip and a span defined therebetween. Each blade 34 defines a central blade axis 156. For this embodiment, each blade 34 of the propeller assembly 32 is rotatable about its central blade axis 156, e.g., in unison with one another. One or more actuators 158 are provided to facilitate such rotation and therefore may be used to change a pitch of the blades 34 about their respective central blades' axes 156.

The fan section 150 further includes a fan guide vane array 160 that includes the vanes 42 disposed around the centerline (CL). For this embodiment, the vanes 42 are not rotatable about the centerline (CL). Each vane 42 has a root and a tip and a span defined therebetween.

Each vane 42 defines a central blade axis 164. For this embodiment, each vane 42 of the fan guide vane array 160 is rotatable about its respective central blade axis 164, e.g., in unison with one another. One or more actuators 166 are provided to facilitate such rotation and therefore may be used to change a pitch of the vane 42 about its respective central blade axis 164. However, in other embodiments, each vane 42 may be fixed or unable to be pitched about its central blade axis 164. The vanes 42 are mounted to a fan cowl 170, which may also be referred to as a nacelle.

As shown in FIG. 12, in addition to the propeller assembly 32, which is unducted, a ducted fan 184 is included aft of the fan 152, such that the unducted fan propulsor 38 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g., coupled to the LP shaft 138). In the embodiment depicted, as noted above, the propeller assembly 32 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 12) arranged in a single stage, such that the ducted fan 184 may be referred to as a single stage fan. The fan blades of the ducted fan 184 can be arranged in equal spacing around the centerline (CL). Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the unducted fan propulsor 38.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 12). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The unducted fan propulsor 38 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the unducted fan propulsor 38 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the unducted fan propulsor 38 further includes an array of inlet guide vanes 186 positioned in the inlet duct 180 upstream of the ducted fan 184 and downstream of the engine inlet 182. The array of inlet guide vanes 186 are arranged around the centerline (CL). For this embodiment, the inlet guide vanes 186 are not rotatable about the centerline (CL). Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the unducted fan propulsor 38 includes an array of outlet guide vanes 190. As with the array of inlet guide vanes 186, the array of outlet guide vanes 190 are not rotatable about the centerline (CL). However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the unducted fan propulsor 38 includes one or more actuators 192 for modulating the variable geometry exhaust nozzle. For example, the variable geometry exhaust nozzle may be configured to vary a total cross-sectional area (e.g., an area of the nozzle in a plane perpendicular to the centerline (CL)) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the unducted fan propulsor 38 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 12, in exemplary embodiments, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through fan duct 172 as a heat sink and correspondingly increases the temperature of the air downstream of the heat exchanger 200 and exiting the fan exhaust nozzle 178.

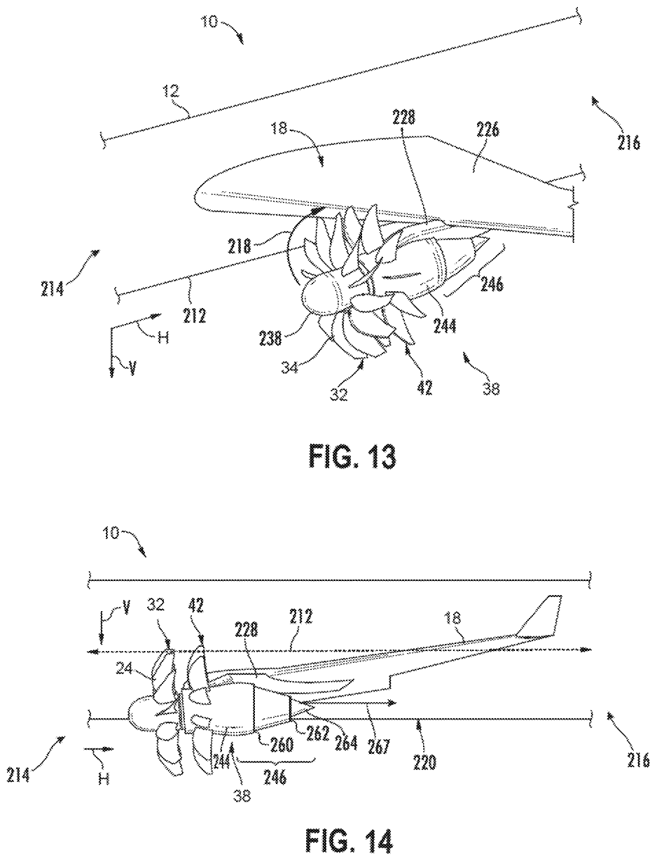

Referring now to FIG. 13, a perspective view of a portion of the aircraft 10 having an unducted fan propulsor 38 will be discussed. Referring also to FIG. 14, a side view of the aircraft 10 is also provided.

The aircraft 10 includes the fuselage 12, a wing 18 (with an upper surface 226), a pylon fairing 228, and the unducted fan propulsor 38, and defines a vertical direction V and a downstream direction H. In this example, downstream direction His a direction of airflow from a front or forward end 214 (e.g., to the left in FIG. 14) of aircraft 10 to a rear or aft end 216 (e.g., to the right in FIG. 14) of aircraft 10. The unducted fan propulsor 38 of the aircraft 10 includes the propeller assembly 32 having the array of blades 34, a spinner or nose 238, the array of vanes 42, a casing 244, and an exhaust section 246. Further, propeller assembly 32 defines a direction of rotation 218.

As will be appreciated from the view of FIG. 14, aircraft 10 further defines a fuselage centerline 212 (which lies in the fuselage centerplane (FCB) (FIGS. 6C-6E), and the unducted fan propulsor 38 further includes a bypass outlet nozzle 260, an outlet nozzle 262, and a core plug 264, and defines an exhaust stream 267.

The fuselage 12 is a main body or vessel section of aircraft 10 that contains cargo, passengers, a crew, or a combination thereof during normal operation. The wing 18 is an aerodynamic portion of aircraft 10 that provides lift for aircraft 10. The wing 18 is mounted to and extends from fuselage 12. The upper surface 226 is a surface extending along a top-side of the wing 18a relative to vertical direction V (shown as pointing downwards in FIG. 13). As will be appreciated, the wing 18 may define an airfoil shape, and upper surface 226 may be a suction side of the airfoil. Such a configuration may cause an upwash of the airflow approaching the wing 18 during flight.

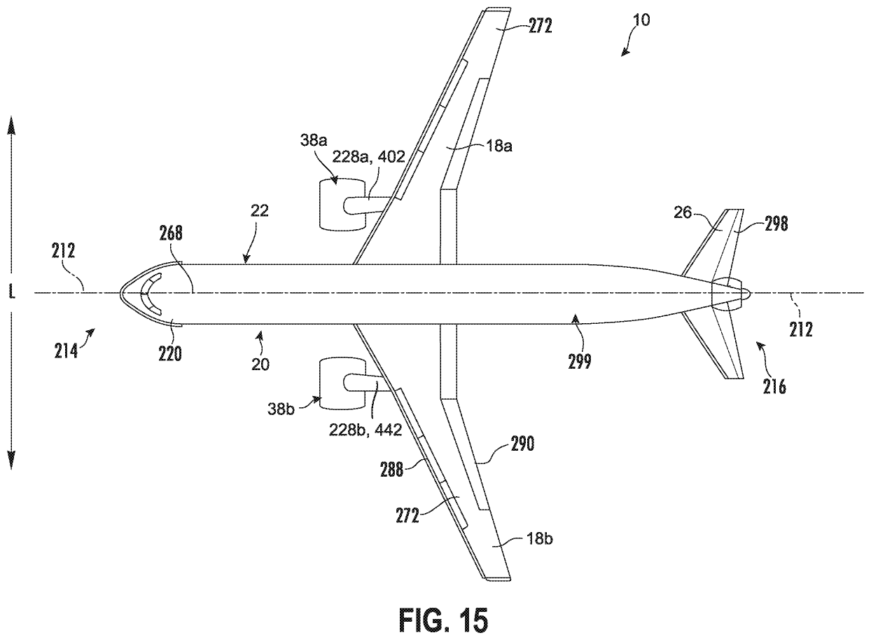

Referring now also to FIG. 15, a top view of an exemplary aircraft 10 according to another embodiment of the present disclosure is provided. FIG. 15 provides an aircraft 10 that defines a longitudinal centerline 212 that extends therethrough, a lateral direction L, a forward end 214, and an aft end 216. Moreover, the aircraft 10 defines a mean line 268 extending between the forward end 214 and aft end 216 of the aircraft 202. As used herein, the “mean line” refers to a midpoint line extending along a length of the aircraft 202, not taking into account the appendages of the aircraft 10 (such as the wings 18a, 18b).

Moreover, the aircraft 10 includes a fuselage 12, extending longitudinally from the forward end 214 of the aircraft 10 towards the aft end 216 of the aircraft 10, and a wing assembly 272. In an exemplary embodiment of the present disclosure, the wing assembly 272 includes a first primary wing 18a and a second primary wing 18b. For example, the first primary wing 18a extends laterally outwardly with respect to the longitudinal centerline 212 from a first or starboard side 22 of the fuselage 12 and the second primary wing 18b extends laterally outwardly with respect to the longitudinal centerline 212 from a second or port side 20 of the fuselage 12. Each of the primary wings 18a, 18b for the exemplary embodiment depicted may include one or more leading edge flaps 288 and one or more trailing edge flaps 290. The aircraft 10 further includes a vertical stabilizer having a rudder flap for yaw control, and a pair of horizontal stabilizers 26, each having an elevator flap 298 for pitch control. The fuselage 12 additionally includes an outer surface 299.

The exemplary aircraft 10 of FIG. 15 also includes a propulsion system. In an exemplary embodiment, the exemplary propulsion system includes a plurality of aircraft engines, at least one of which is mounted to each of the primary wings 18a, 18b. For example, the plurality of aircraft engines includes a first aircraft engine 38a mounted to the first primary wing 18a and a second aircraft engine 18b mounted to the second primary wing 18b.

Referring back to FIGS. 13 and 14, for the embodiment depicted, the aircraft 10 includes the pylon fairing 228. The pylon fairing 228 is a mount extending between the wing 18 and the unducted fan propulsor 38. The pylon fairing 228 connects the unducted fan propulsor 38 to the wing 18. In particular, for the embodiment of FIG. 15, the aircraft 10 includes a pylon fairing 228a to connect the first aircraft engine 18a, e.g., a first unducted fan propulsor, to the first primary wing 18a and includes another pylon fairing 228b to connect the second aircraft engine 38b, e.g., a second unducted fan propulsor, to the second primary wing 18b.

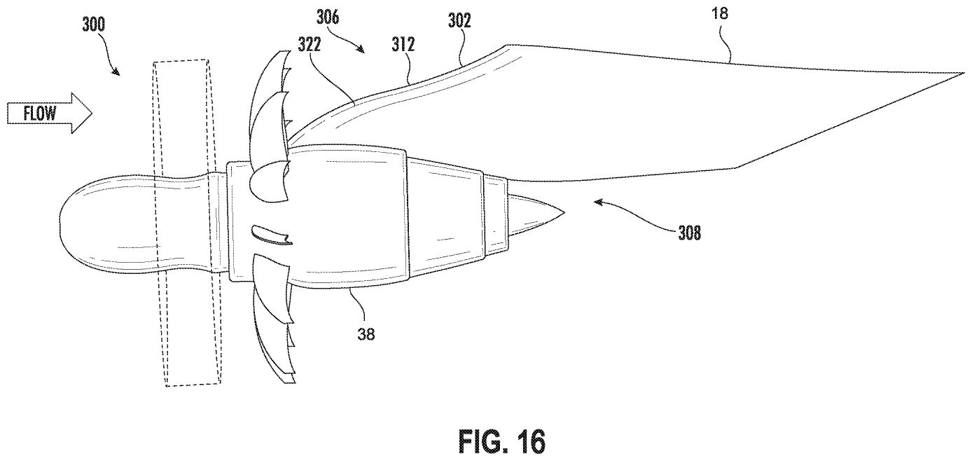

Referring now generally to FIGS. 16 through 18, in exemplary embodiments of the present disclosure, an open rotor pylon system 300 including a pylon fairing 302 includes an improved thickness distribution along a lengthwise direction 304 of the pylon fairing 302 will now be described in detail below. It is contemplated that the aerodynamically designed pylon fairings of the present disclosure may be implemented on an underwing installation as shown in FIG. 16.

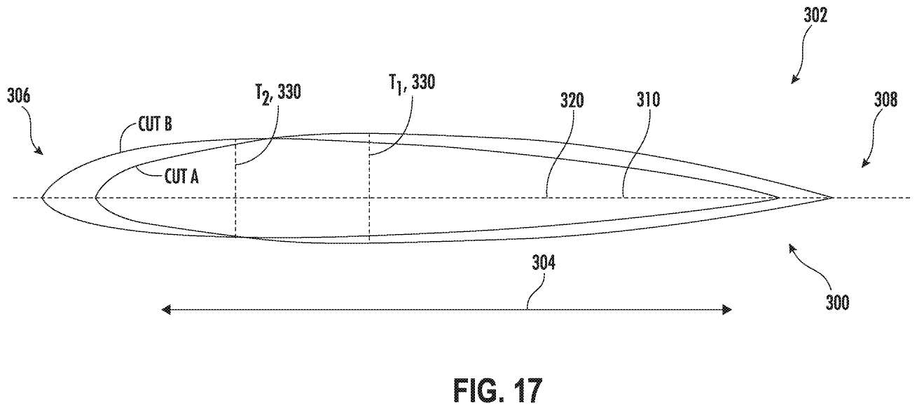

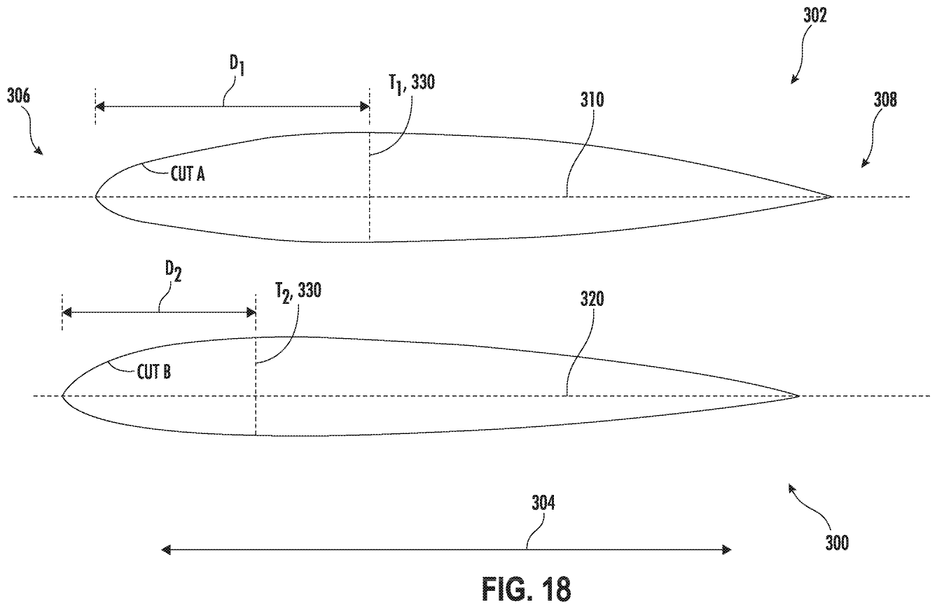

Referring now to FIG. 16, a side perspective view of the open rotor pylon system 300 including the pylon fairing 302 is provided. Referring also to FIG. 17, a cross-section view of a first chord 310 (CUT A) of the pylon fairing 302, e.g., at a first position 312, and a second chord 320 (CUT B) of the pylon fairing 302, e.g., at a second position 322, with the first chord 310 and the second chord 320 in an overlapping configuration is provided. Referring also to FIG. 18, a cross-section view of the first chord 310 (CUT A) of the pylon fairing 302, e.g., at a first position 312, and the second chord 320 (CUT B) of the pylon fairing 302, e.g., at a second position 322, with the first chord 310 and the second chord 320 shown separated is provided.

Referring to FIGS. 16-18, the pylon fairing 302 defines a lengthwise direction 304, a leading edge 306, a trailing edge 308, the first chord 310 (CUT A) extending from the leading edge 306 to the trailing edge 308 at the first position 312 along the lengthwise direction 304, and the second chord 320 (CUT B) extending from the leading edge 306 to the trailing edge 308 at the second position 322 along the lengthwise direction 304.

Advantageously, the pylon fairing 302 includes a first maximum thickness portion T1 at a first percentage of the first chord 310 and a second maximum thickness portion T2 at a second percentage of the second chord 320. The first percentage of the first maximum thickness portion T1 is different than the second percentage of the second maximum thickness portion T2.

For example, in certain embodiments, the first maximum thickness portion T1 is located between 30% and 60% of the first chord 310 from the leading edge 306. For example, in other certain embodiments, the first maximum thickness portion T1 is located between 35% and 60% of the first chord 310 from the leading edge 306. For example, in yet other certain embodiments, the first maximum thickness portion T1 is located between 40% and 60% of the first chord 310 from the leading edge 306.

For example, in certain embodiments, the second maximum thickness portion T2 is located between 10% and 40% of the second chord 320 from the leading edge 306. For example, in other certain embodiments, the second maximum thickness portion T2 is located between 15% and 40% of the second chord 320 from the leading edge 306. For example, in yet other certain embodiments, the second maximum thickness portion T2 is located between 20% and 40% of the second chord 320 from the leading edge 306.

In an exemplary embodiment of the present disclosure, the first maximum thickness portion T1 is located a first distance D1 from the leading edge 306 and the second maximum thickness portion T2 is located a second distance D2 from the leading edge 306. Furthermore, the second distance D2 is less than the first distance D1.

In another exemplary embodiment of the present disclosure, the pylon fairing 302 includes a maximum thickness portion 330 along the lengthwise direction 304 of the pylon fairing 302 located between 10% and 60% of a chord of the pylon fairing 302. In this manner, the maximum thickness portion 330 of the present disclosure allows for the control of the acceleration and/or deceleration of the open rotor pylon system 300. For example, the maximum thickness portion 330 of the present disclosure allows for the control of the acceleration and/or deceleration of a prop wash within the constraints of the nacelle blockage, pylon blockage, and/or wing blockage to mitigate the shock losses that may occur due to supersonic flow at a high speed cruise condition. Furthermore, a variable maximum thickness portion 330 of the present disclosure also allows for balancing both the transonic flow around the pylon fairing 302 with the internal packaging constraints of an engine system mounted inside the pylon fairing 302. By controlling the location of the maximum thickness portion 330 of the pylon fairing 302 as described herein, the present disclosure allows for control of the flow area from upstream to downstream of the pylon fairing 302.

In other certain embodiments, the pylon fairing 302 includes a maximum thickness portion 330 along the lengthwise direction 304 of the pylon fairing 302 located between 20% and 50% of a chord of the pylon fairing 302. In yet other certain embodiments, the pylon fairing 302 includes a maximum thickness portion 330 along the lengthwise direction 304 of the pylon fairing 302 located between 30% and 40% of a chord of the pylon fairing 302.

In one exemplary embodiment, the maximum thickness portion 330 is closer to the leading edge 306 proximate the unducted fan propulsor 38. In other exemplary embodiments, the maximum thickness portion 330 is closer to the trailing edge 308.

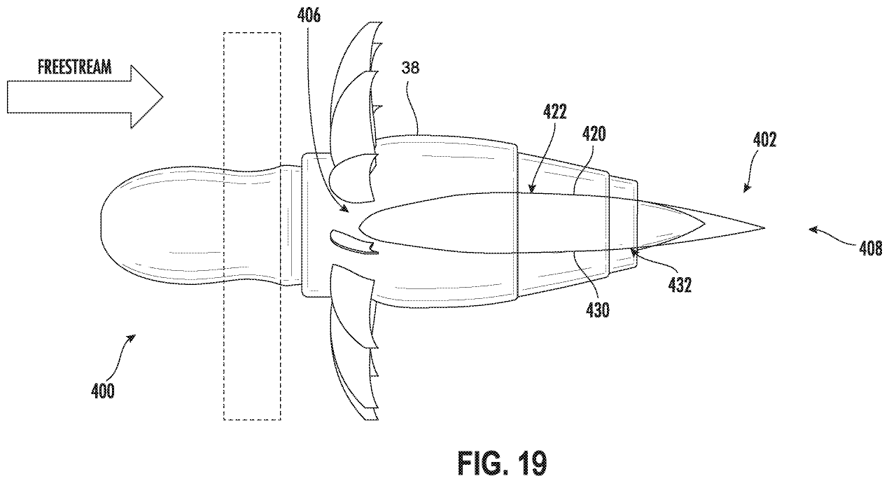

Referring now generally to FIGS. 19 through 21B, in exemplary embodiments of the present disclosure, an open rotor pylon system 400 including a pylon fairing 402 that includes a first suction side 420 and a first pressure side 430 will now be described in detail below.

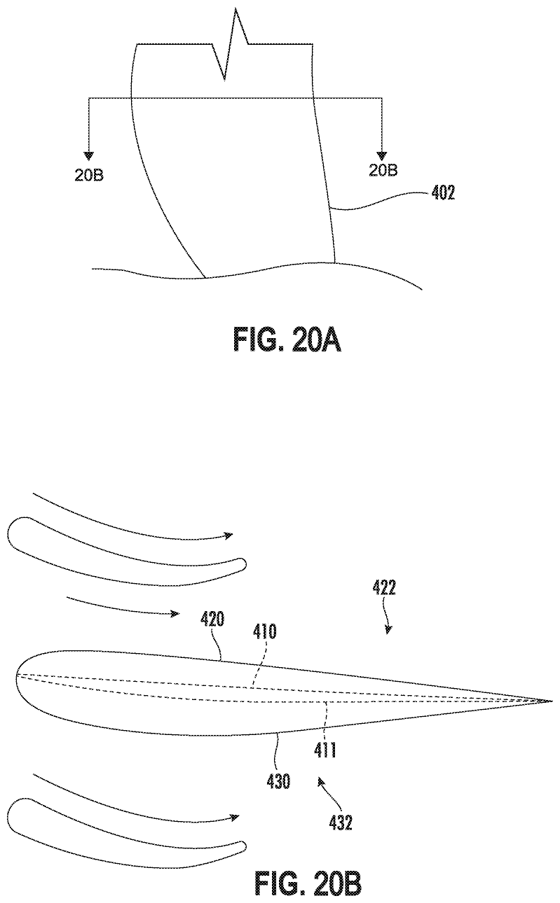

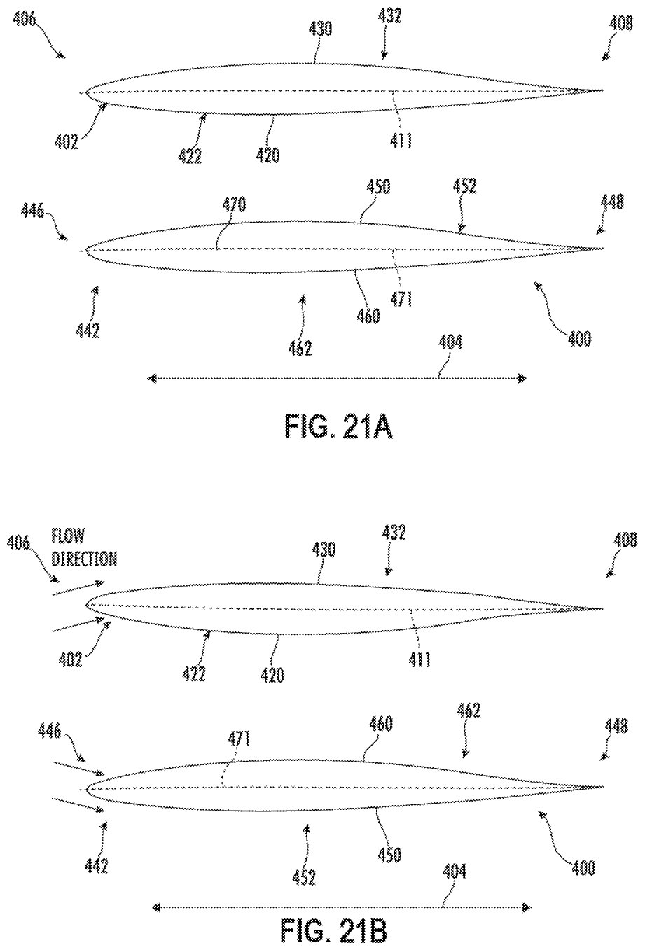

Referring now to FIG. 19, a perspective view of an open rotor pylon system 400 including a pylon fairing 402 is provided. Referring also to FIG. 20A, a side elevation view of the pylon fairing 402 is provided. Referring also to FIG. 20B, a cross-section view of the pylon fairing 402, taken along line 20B-20B of FIG. 20A, is provided. Referring also to FIGS. 21A and 21B, cross-section views of the first pylon fairing or pylon fairing 402 and a cross-section view of a second pylon fairing 442 according to exemplary embodiments are provided. The first pylon fairing 402 may be used to connect a first aircraft engine to a first wing of an aircraft and the second pylon fairing 442 may be used to connect a second aircraft engine to a second wing of an aircraft.

Referring to FIGS. 19-21B, the pylon fairing 402 defines a lengthwise direction 404, a leading edge 406, a trailing edge 408, a chord 410 and a camber 411 extending from the leading edge 406 to the trailing edge 408, the first pressure side 420, and the first suction side 430. Advantageously, the first pressure side 420 of the pylon fairing 402 defines a first shape 432, and the first suction side 430 of the pylon fairing 402 defines a second shape 422 different than the first shape 432. In this manner, the difference in shape and/or curvature of the first pressure side 420 and the first suction side 430 of the pylon fairing 402 is configured to maximize de-swirl capability.

Furthermore, an outlet guide vane (e.g., the vanes 42 (FIG. 12)) is designed to limit the swirl imparted on a prop stream flow by the rotor. However, the outlet guide vane is not perfectly efficient and some amount of residual swirl downstream of the outlet guide vane is possible when the engine is installed on the aircraft. The pylon fairing 402 of the present disclosure is designed to tolerate some amount of residual swirl and may also act as a crude outlet guide vane to remove some swirl that is not removed by the outlet guide vanes. The prop and outlet guide vane exit swirl profiles vary with radius. Accordingly, the shape of the pylon fairing 402 (e.g., section cuts) will also vary with radius. As such, the pylon fairing 402 of the present disclosure, designed to act like a crude outlet guide vane, is configured to have suction and pressure sides defining different shapes as described herein. In other words, the swirl changes from hub to tip. Accordingly, the first pressure side 420 and first suction side 430 of the pylon fairing 402 changes hub to tip to accommodate the changing swirl and mitigate drag.

In exemplary embodiments of the present disclosure, the geometries of the first pressure side 420 of the pylon fairing 402 defining the first shape 432 and the first suction side 430 of the pylon fairing 402 defining the second shape 422 different than the first shape 432 are configured such that the maximum thickness value and location of each is designed for minimum drag by controlling the strength and location of the likely shock. The degree of incoming swirl expected by each side of the first pressure side 420 and the first suction side 430 will also influence a bluntness. Each of the first pressure side 420 and the first suction side 430 of the pylon fairing 402 is a non-symmetric airfoil having distinctive lift and drag characteristics that depend on incidence angle (e.g., swirl angle) and oncoming velocity (e.g., outlet guide vane exit velocity which varies radially).

Referring to FIG. 21A, in an exemplary configuration, the second pylon fairing 442 has a greater max thickness to chord ratio than the pylon fairing 402 which enables a more efficient pylon fairing design. Furthermore, the second pylon fairing 442 defines a pylon waterline section at a different spanwise location between the nacelle and the wing.

Referring to FIG. 21B, in another exemplary configuration, the second pylon fairing 442 defines a camber 471 opposite the camber 411 of the pylon fairing 402. In this manner, the second pylon fairing 442 is designed for a different outlet guide vane exit camber orientation.

In an exemplary embodiment of the present disclosure, the geometry of the first shape 432 of the first suction side 430 changes along a spanwise direction of the pylon fairing 402. Furthermore, in an exemplary embodiment of the present disclosure, the geometry of the second shape 422 of the first pressure side 420 changes along a spanwise direction of the pylon fairing 402. The views depicted in FIGS. 21A and 21B are each taken from a common spanwise position (e.g., as a percent of total span).

In an exemplary embodiment of the present disclosure, the first shape 432 and the second shape 422 are different at the same location along the lengthwise direction 404 of the pylon fairing 402.

Referring now also to FIG. 15, as described above, the first primary wing 18a extends laterally outwardly with respect to the longitudinal centerline 212 from the first or starboard side 22 of the fuselage 12 and the second primary wing 18b extends laterally outwardly with respect to the longitudinal centerline 212 from the second or port side 20 of the fuselage 12. In an exemplary embodiment of the present disclosure, the open rotor pylon system 400 of the present disclosure includes the pylon fairing 402, i.e., a first pylon fairing 402, that connects a first aircraft engine 38a to the first wing 18a and a second pylon fairing 442 that connects a second aircraft engine 38b to the second primary wing 18b. In such a manner, it will be appreciated that although the first and second pylon fairings 402, 442 are positioned next to each other in FIGS. 21A, 21B for convenience, in practice the first and second pylon fairings 402, 442 may be spaced from one another, such as positioned on opposite sides of a fuselage of an aircraft.

Referring again to FIGS. 21A and 21B, the second pylon fairing 442 also defines a lengthwise direction 404 and includes a leading edge 446, a trailing edge 448, a chord (not labeled) extending from the leading edge 446 to the trailing edge 448, a second pressure side 460, and a second suction side 450. In exemplary embodiments, the second pressure side 460 of the second pylon fairing 442 defining a third shape 452, and the second suction side 450 of the second pylon fairing 442 defining a fourth shape 462 different than the third shape 452.

In certain embodiments, the third shape 452 of the second pressure side 460 of the second pylon fairing 442 and the first shape 432 of the first suction side 430 of the first pylon fairing 402 are the same. In other certain embodiments, the third shape 452 of the second pressure side 460 of the second pylon fairing 442 and the first shape 432 of the first suction side 430 of the first pylon fairing 402 are different.

In other certain embodiments, the fourth shape 462 of the second suction side 460 of the second pylon fairing 442 and the second shape 422 of the first pressure side 430 of the first pylon fairing 402 are the same. In other certain embodiments, the fourth shape 462 of the second suction side 460 of the second pylon fairing 442 and the second shape 422 of the first pressure side 430 of the first pylon fairing 402 are different.

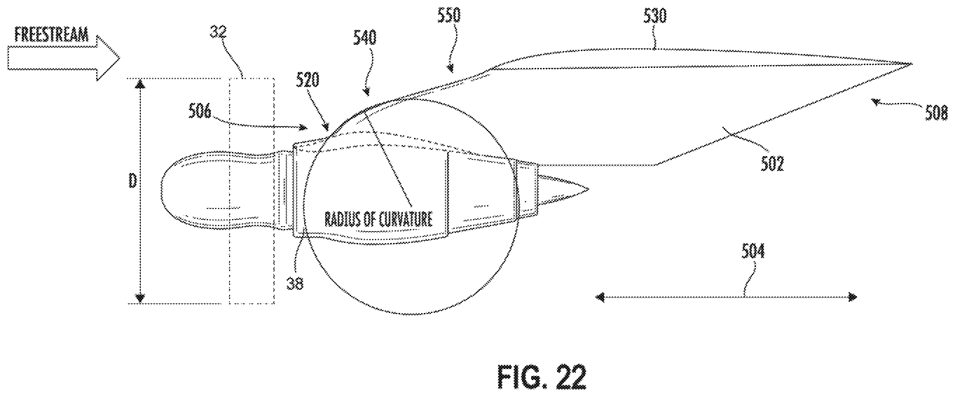

Referring now to FIG. 22, in another exemplary embodiment of the present disclosure, illustrated is a perspective view of an open rotor pylon system 500 including a pylon fairing 502 that defines a lengthwise direction 504, a leading edge 506, a trailing edge 508, and includes a first inflection point 520 along the leading edge 506 will now be described in detail below.

As described above, the unducted fan propulsor 38 includes the propeller assembly 32 with the array of blades 34 (FIG. 12). The blades 34 define a fan diameter D. Advantageously, in an exemplary embodiment, the first inflection point 520 defines a first radius of curvature that is less than 5 times the fan diameter D and greater than 0.1 times the fan diameter D. In this manner, additional volume is provided in the pylon fairing 502 and further aerodynamic benefits are realized. For example, the pylon fairing 502 of the present disclosure provides a greater premium to the internal volume of the pylon fairing 502. Furthermore, the first inflection point 520 of the pylon fairing 502 is configured to blend the pylon fairing 502 into the nacelle and the outlet guide vane hub flow path.

In such a manner, the pylon fairing 502 having the first inflection point 520 along the leading edge 506 defines a generally duckbill shape. Advantageously, the duckbill shape of the present disclosure creates additional internal volume for the pylon fairing 502. Also, such a duckbill shape provides a long and thin shape that reduces the drag associated with supersonic flow at cruise conditions. Furthermore, the duckbill shape allows a longer chord and allows the pylon fairing 502 to begin controlling the flow through a gully portion earlier.

In an exemplary embodiment, the first inflection point 520 of the pylon fairing 502 is located at a position closer to the unducted fan propulsor 38 than the wing 18 (FIG. 13).

In the exemplary embodiment, the pylon fairing 502 includes a second inflection point 540 along the leading edge 506 of the pylon fairing 502 downstream of the first inflection point 520. The second inflection point 540 defines a second radius of curvature that is less than 3 times the fan diameter D and greater than 0.1 times the fan diameter. Advantageously, the second inflection point 540 is configured to provide better control of a flow of air over the leading edge 506 of the pylon fairing 502 into the wing. The shape provided by the second inflection point 540 of the pylon fairing 502 minimizes interference drag and minimizes the impact to wing lift.

In the exemplary embodiment, the pylon fairing 502 includes a third inflection point 550 along the leading edge 506 of the pylon fairing 502 downstream of the first inflection point 520 and the second inflection point 540. The third inflection point 550 defines a third radius of curvature that is less than 3 times the fan diameter D and greater than 0.1 times the fan diameter. Advantageously, the second inflection point 540 and the third inflection point 550 of the present disclosure are configured to define the shape of the pylon fairing 502 that is exposed to a majority of the prop wash. Furthermore, the second inflection point 540 and the third inflection point 550 of the present disclosure negotiate outlet guide vane exit flow around the pylon fairing 502 and into the wing.

In the exemplary embodiment, the pylon fairing 502 also includes a cantilevered stator vane 530. It is contemplated that the cantilevered stator vane 530 is stationary.

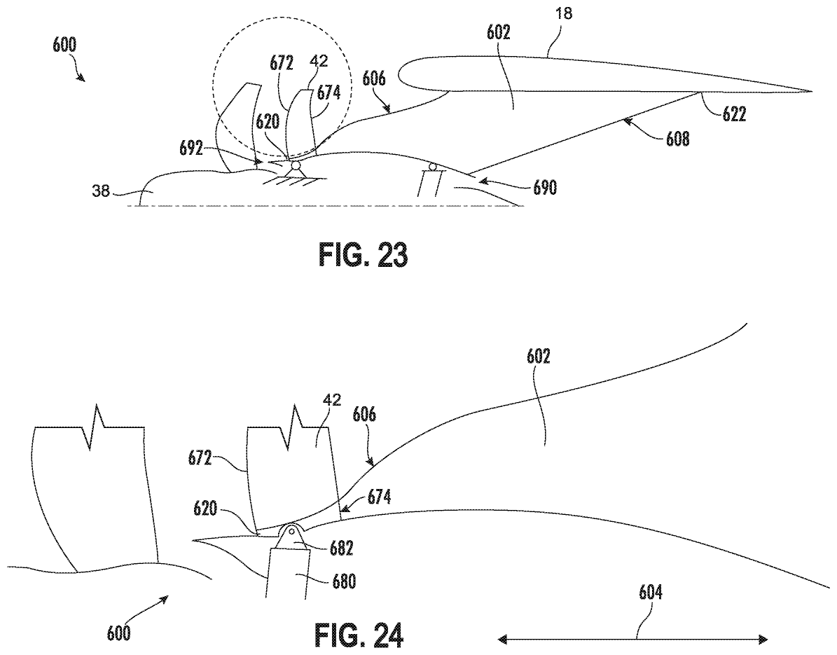

Referring now generally to FIGS. 23 and 24, in another exemplary embodiment of the present disclosure, an open rotor pylon system 600 including a pylon fairing 602 that includes a forwardmost point 620 that covers a portion of the unducted fan propulsor 38 will now be described in detail below.

Referring now to FIG. 23, a side elevation view of the open rotor pylon system 600 including the pylon fairing 602 is provided. Referring also to FIG. 24, a schematic view of the open rotor pylon system 600 including the pylon fairing 602 is provided.

Referring to FIGS. 23 and 24, the pylon fairing 602 defines a lengthwise direction 604, a leading edge 606, a trailing edge 608, a forwardmost point 620, and a rearmost point 622.

The unducted fan propulsor 38 also includes a vane 42, a forward compressor frame 680, a core nozzle exit 690 (e.g., the turbomachine exhaust nozzle 140 (FIG. 12)), and an inlet lip 692 (e.g., the engine inlet 182 (FIG. 12)). The vane 42 includes a leading edge 672 and a trailing edge 674. The forward compressor frame 680 includes a mount 682.

Advantageously, in an exemplary embodiment, the forwardmost point 620 of the pylon fairing 602 is disposed upstream of the trailing edge 674 of the vane 42. In this manner, the forwardmost point 620 of the pylon fairing 602 is configured to enable drag reduction.

Advantageously, in another exemplary embodiment, the forwardmost point 620 of the pylon fairing 602 is disposed upstream of the mount 682 of the forward compressor frame 680, i.e., the forwardmost point 620 of the pylon fairing 602 covers the mount 682 of the forward compressor frame 680. In this manner, the forwardmost point 620 of the pylon fairing 602 is configured to enable drag reduction and provide structural protection to the mount 682 of the forward compressor frame 680.

Referring to FIG. 23, in an exemplary embodiment of the present disclosure, the forwardmost point 620 of the pylon fairing 602 extends to the inlet lip 692 of the unducted fan propulsor 38 and the rearmost point 622 extends to the core nozzle exit 690 of the unducted fan propulsor 38.

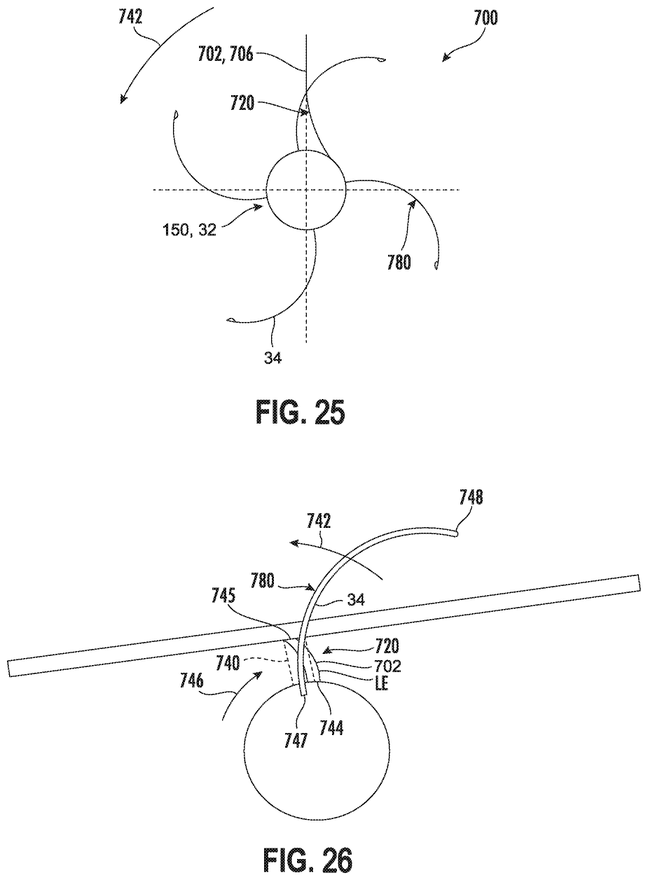

Referring now generally to FIGS. 25 and 26, in another exemplary embodiment of the present disclosure, an open rotor pylon system 700 including a pylon fairing 702 that defines a pylon fairing dihedral 720 will now be described in detail below. It will be appreciated that the dihedral 720 depicted schematically in FIGS. 25 and 26 is a schematic projection a leading edge 706 of the pylon fairing 702 in a cross-stream view.

Referring now to FIG. 25, a first schematic view of the open rotor pylon system 700 including the pylon fairing 702 is provided. Referring also to FIG. 26, a second schematic view of the open rotor pylon system 700 including the pylon fairing 702 is provided.

Referring to FIGS. 25 and 26, the pylon fairing 702 defines the leading edge 706 and the pylon fairing dihedral 720. In an exemplary embodiment, the pylon fairing dihedral 720 is at the leading edge 706 of the pylon fairing 702. In an exemplary embodiment, the pylon fairing dihedral 720 extends a length of the leading edge 706 of the pylon fairing 702. In another exemplary embodiment of the present disclosure, the pylon fairing dihedral 720 extends an entirety of the length of the leading edge 706 of the pylon fairing 702. In an exemplary embodiment, the pylon fairing 702 includes a pylon fairing body 740 downstream of the leading edge 706. In an exemplary embodiment, the pylon fairing body 740 downstream of the leading edge 706 is radially aligned, i.e., the pylon fairing body 740 does not include the pylon fairing dihedral 720.

As described above, the unducted fan propulsor 38 (FIG. 12) includes an unducted fan section 150 (also shown in FIG. 1) having a propeller assembly 32 (also shown in FIG. 12) that includes an array of blades 34, with each blade 34 defining a fan trailing edge lean 780 or trailing edge lean profile. During operation, a rotation of the blades 34 generates a fan wake having a sheared profile with a lean relative to the direction of rotation.

Advantageously, in an exemplary embodiment, the pylon fairing 702 defines a pylon fairing dihedral 720 that is in a direction opposite the fan trailing edge lean 780. In this manner, the pylon fairing dihedral 720 is configured to increase a phasing or rate of time of the gust interaction due to the sheared fan wakes of the propeller assembly 32 impinging on the pylon leading edge.

In particular, it will be appreciated that during operation the array of blades of the propeller assembly 32 (FIG. 12) generate a wake that travels downstream from the propeller assembly 32 due to a local pressurization of an airflow through the array of blades 34. In order to offset an arrival of the wake from an individual blade 34 at the pylon fairing 702, the pylon fairing 702 defines the pylon fairing dihedral 720. Notably, the blade 34 defines a dihedral, which provides an initial offset of the wake arrival at the pylon fairing 702. By providing a dihedral of the pylon fairing 702 opposite the direction of the sheared fan wakes, further time delay may be provided to the wake interaction with the pylon, thereby reducing the interaction noise emanating from the pylon leading edge. Such a configuration may reduce a noise generated during operation of the unducted fan propulsor 38 (FIG. 12).

Furthermore, referring still to FIGS. 25 and 26, the propeller assembly 32 includes a blade 34 that rotates in a first direction 742. In an exemplary embodiment, the pylon fairing dihedral 720 is in the first direction 742 from a base 744 to a top 745 of the pylon fairing 702, and the fan trailing edge lean 780 is in a second direction 746 opposite the first direction 742 from a root 747 to a tip 748 of the blade 34.

In another exemplary embodiment, a portion of the pylon fairing 702 that is downstream of the leading edge 706 is radially still, i.e., that does not include the pylon fairing dihedral 720.

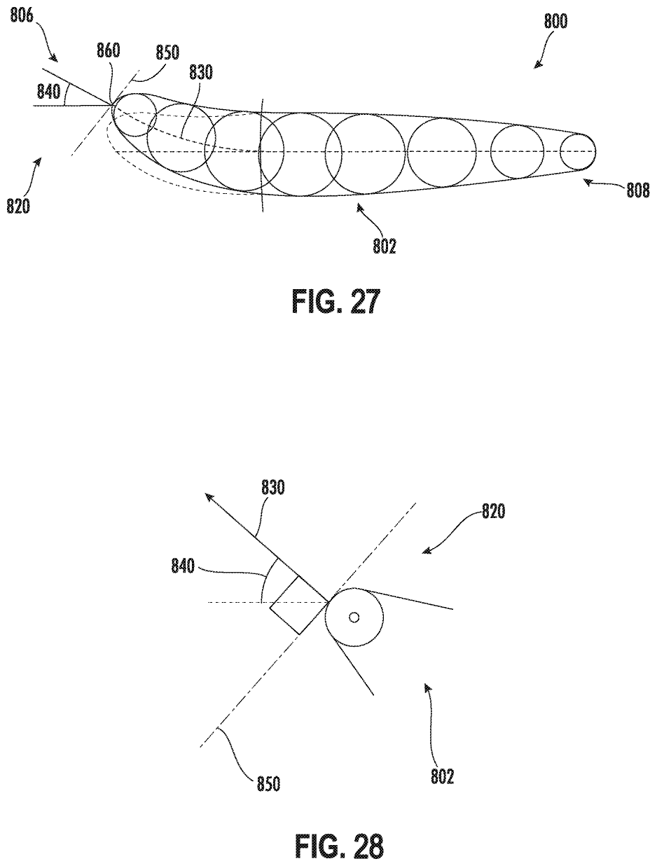

Referring now generally to FIGS. 27-31, in another exemplary embodiment of the present disclosure, an open rotor pylon system 800 including a pylon fairing 802 having a leading edge section 820 that defines a leading edge camber 830 that varies will now be described in detail below.

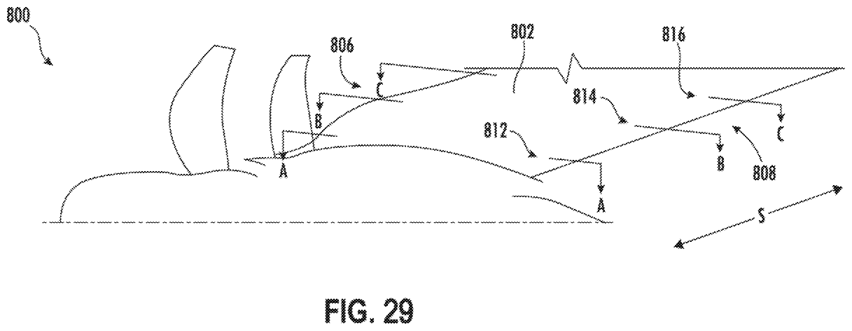

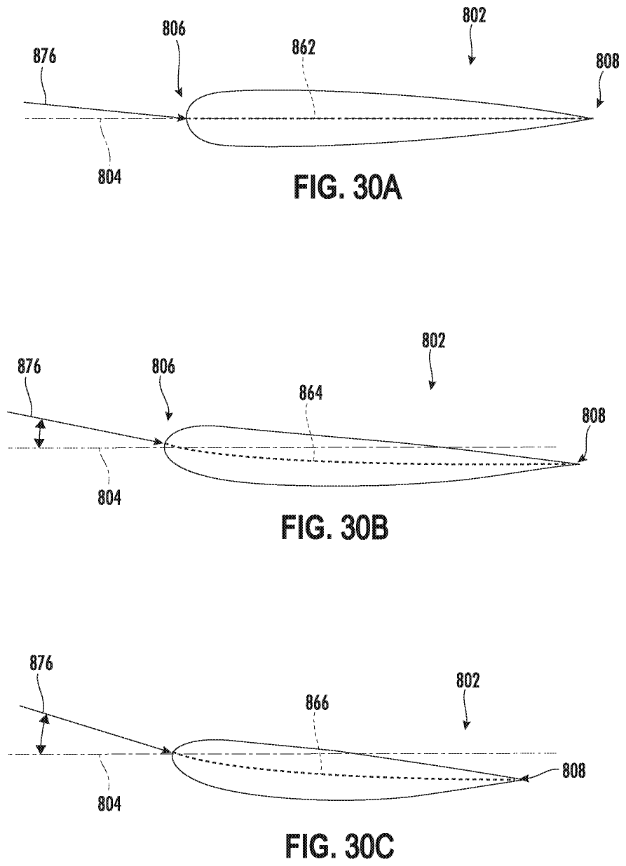

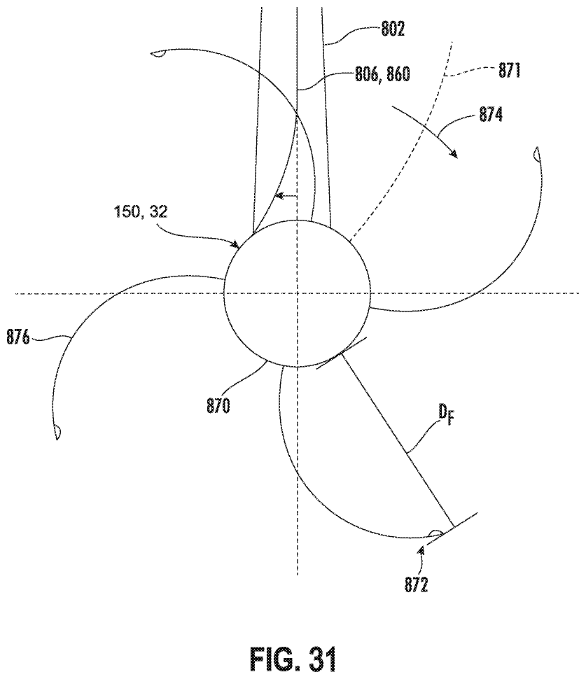

Referring now to FIG. 27, a cross-section view of the open rotor pylon system 800 including the pylon fairing 802 is provided. Referring also to FIG. 28, a first schematic view of the leading edge section 820 of the pylon fairing 802 is provided. Referring also to FIG. 29, a side perspective view of the open rotor pylon system 800 including the pylon fairing 802 is provided. Referring also to FIG. 30A, a cross-sectional view taken along line A-A of FIG. 29 of a first portion of the pylon fairing 802, e.g., at a first position 812 along a spanwise direction S of the pylon fairing 802 is provided. Referring also to FIG. 30B, a cross-sectional view taken along line B-B of FIG. 29 of a second portion of the pylon fairing 802, e.g., at a second position 814 along the spanwise direction S of the pylon fairing 802 is provided. Referring also to FIG. 30C, a cross-sectional view taken along line C-C of FIG. 29 of a third portion of the pylon fairing 802, e.g., at a third position 816 along the spanwise direction S of the pylon fairing 802 is provided. Referring also to FIG. 31, a second schematic view of an open rotor pylon system 800 including a pylon fairing 802 is provided.

Referring to FIGS. 27-31, the pylon fairing 802 defines a lengthwise direction 804, a leading edge 806, a trailing edge 808, and the leading edge section 820 at the leading edge 806. Advantageously, the leading edge section 820 defines the leading edge camber 830 that varies along the lengthwise direction 804 of the pylon fairing 802.

In an exemplary embodiment, the leading edge section 820 also defines a leading edge angle 840 that is defined as an angle between the leading edge camber 830 and the axial direction A (see FIG. 12). The pierce point 860 is the point of intersection between the leading edge camber 830 (or camberline, also referred to as the mean camber line) and the airfoil surface of the pylon fairing 802.

In exemplary embodiments, it is contemplated that the leading edge camber angle 840 is between approximately 5 degrees and approximately 60 degrees. In other exemplary embodiments, the leading edge angle 840 is between approximately 10 degrees and approximately 50 degrees. In further exemplary embodiments, the leading edge angle 840 is between approximately 15 degrees and approximately 45 degrees.

As described above, the unducted fan propulsor 38 (FIG. 12) includes an unducted fan section 150 (also shown in FIG. 12) having the propeller assembly 32 (FIG. 12) that includes an array of blades 34 that generate wakes 876 (FIG. 12). Referring to FIG. 31, a single trailing edge 871 of a blade is depicted in phantom, having a lean profile relative to a direction of rotation 874 of the unducted fan blade. It will be appreciated that during operation of the propeller assembly 32, the blades generate fan wakes 876 extend a distance DF outward from an engine hub 870 to a fan tip vortex 872. As will be appreciated, the fan wakes 876 have a sheared profile, which develops as the fan wakes 876 move from the propeller assembly 32 towards the pylon fairing 802.

In an exemplary embodiment, the leading edge camber 830 decreases from proximate the engine hub 870 to radially outward distances from the hub toward a fan blade tip 876. In another exemplary embodiment, the leading edge camber 830 is a minimum proximate the engine hub 870 relative to the fan blade tip 876.

Inclusion of the leading edge camber 830 having the variance depicted may allow for an increase in a phasing or rate of time of the fan wake 876 interactions with the pylon fairing leading edge. Such may reduce a noise generated, reduce stress on the parts, provide increases in efficiency, or a combination thereof.

Referring to FIGS. 30A-30C, the pylon fairing 802 defines a lengthwise direction 804, a spanwise direction S (see FIG. 29), a leading edge 806, a trailing edge 808, a first mean camber line 862 (CUT A-A) extending from the leading edge 806 to the trailing edge 808 at the first position 812 along the spanwise direction S; a second mean camber line 864 (CUT B-B) extending from the leading edge 806 to the trailing edge 808 at a second position 814 along the spanwise direction S; and a third mean camber line 866 (CUT C-C) extending from the leading edge 806 to the trailing edge 808 at a third position 816 along the spanwise direction S. Each of FIGS. 30A-30c shown an incoming fan wake 876, which are approaching at the directions shown relative to the lengthwise direction 804 (which may be parallel to a forward direction of the aircraft).

In the embodiment shown, the fan wake 876 at the position in FIG. 30A represents a relatively low swirl relative to the lengthwise direction (e.g., less than 5 degrees). The fan wake 876 at the position in FIG. 30B represents a higher swirl than shown at the position in FIG. 30A relative to the lengthwise direction (e.g., between 5 and 15 degrees). The fan wake 876 at the position in FIG. 30C represents a higher swirl than shown at the positions in FIG. 30A, 30B relative to the lengthwise direction (e.g., greater than 15 degrees). The differences in the mean camber lines, and more specifically in the leading edge cambers, at these different locations may allow for the pylon fairing to better receive the fan wake 876 during operation, e.g., with less noise and higher efficiency.

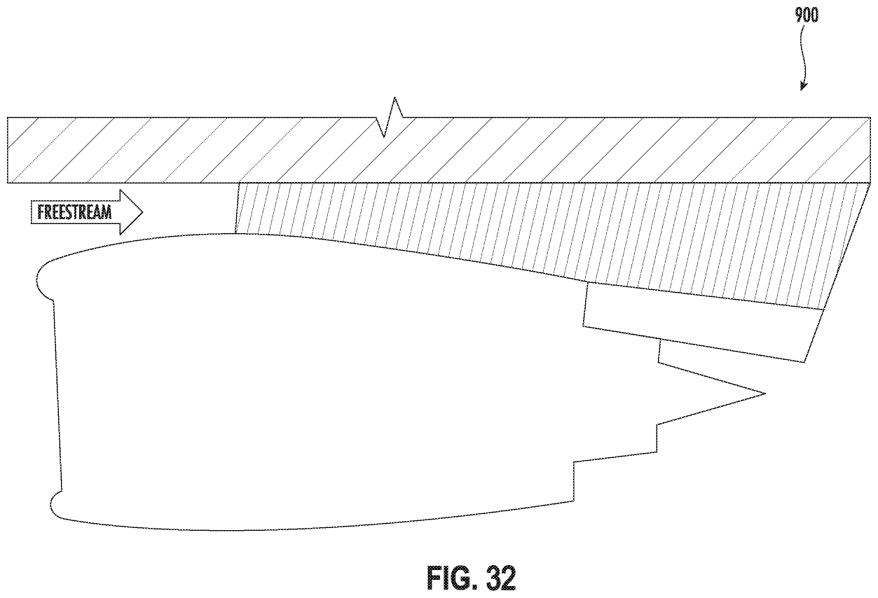

It is contemplated that the aerodynamically designed pylon fairings of the present disclosure may also be implemented on aft fuselage installations 900 of an engine as shown in FIG. 32.

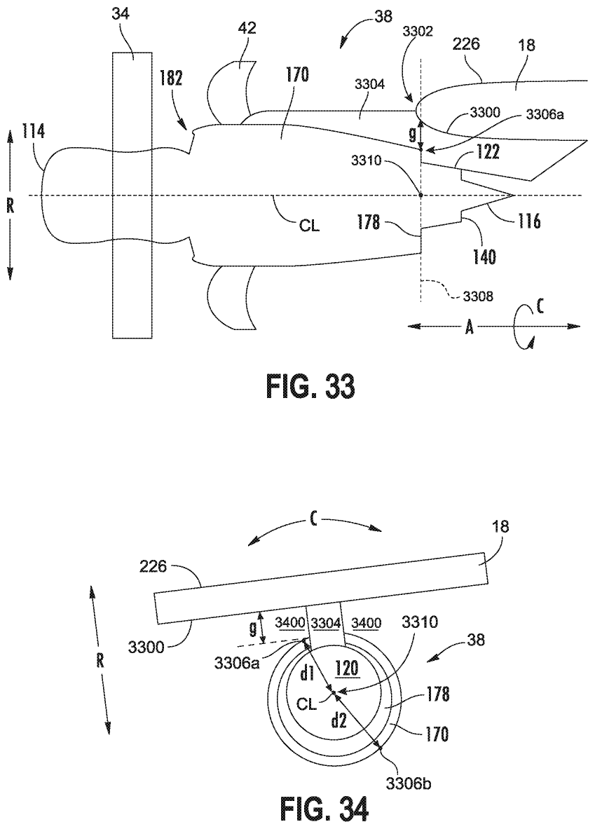

Also disclosed herein are engine designs that help to increase the size of the gully area, which is space between the wing and the gas turbine engine adjacent to the pylon fairing. The example engine designs are described in connection with FIGS. 33-39 and can be implemented in connection with any of the engine locations disclosed above in connection with FIGS. 1-11 and any of the pylon fairing designs of FIGS. 13-32.

Airflow through the gully area is a three-sided channel that passes over a lower surface of the wing, a side surface of the pylon fairing, and an upper surface of the gas turbine engine. The limited space of the gully area causes the airflow to accelerate, and the lower surface of the wing, the side surface of the pylon fairing, and the upper surface of the gas turbine engine create drag on the airflow, also known as scrubbing. The drag is typically worse on an inboard side of the pylon fairing.

The inventors of the present disclosure discovered that, while the drag can be an issue for ducted fans in which the airflow through the gully area is freestream flow, the drag is worse for open fan structures due to the airflow being supercharged through the unducted fan prior to passing through the gully area. The airflow pressurized by the unducted fan may be accelerated by a throat of the gully area, i.e., a section with a minimum area, then may further accelerate at the expanding flow area downstream of the throat. The unducted fan increases the Mach number of the airflow passing through the gully area, which may result in higher drag at the lower surface of the wing, the side surface of the pylon fairing, and the upper surface of the gas turbine engine. Supersonic flow and/or excessive drag can form in the gully area. The higher Mach number of the airflow through the gully area can result in a strong shock and a wave drag penalty that decreases efficiency. Further, when trying to optimize the fan diameter and placement, there is potential conflict, because moving the engine closer to the wing results in a smaller gully area that increases the risk of shock losses. The inventors recognized that increasing the radial distance between the lower surface of the wing and the upper surface of the gas turbine engine would increase the area at the throat, reducing the acceleration at the throat of the gully area, in turn reducing the Mach number of the airflow through the gully area. This may result in reduced drag at the lower surface of the wing, the side surface of the pylon fairing, and the upper surface of the gas turbine engine, reduce the shock at the gully area, and improve efficiency of the aircraft. Further, the example engine designs disclosed herein are particularly beneficial for use on the engine locations disclosed in connection with FIGS. 1-11, because the engine designs enable the engine to be located closer to the under side of the wing (within the design criteria disclosed in connection with FIGS. 1-11) without negatively impacting the size of the gully area. Also, reducing the Mach number enables engine placement on swept wings where inboard and outboard installations experience different airflow speeds.

FIG. 33 is a schematic side view of an unducted fan propulsor 38 attached to a wing 18 of an aircraft in accordance with one or more embodiments of the present disclosure, and FIG. 34 is a schematic view of the unducted fan propulsor 38 and the wing 18 shown in FIG. 33 in a reference plane perpendicular to an axial direction A/centerline (CL) and including a gully distance g. As shown in FIG. 33, the unducted fan propulsor 38 extends from the forward end 114 to the aft end 116 in the axial direction A. The unducted fan propulsor 38 includes the array of blades 34 disposed around the centerline (CL), which are described in detail above. As shown in FIG. 33, the unducted fan propulsor 38 further includes the array of vanes 42 disposed on the fan cowl (a nacelle or housing) 170 of the unducted fan propulsor 38 around the centerline (CL), which are also described in detail above. As shown in FIG. 33, the engine inlet 182 is positioned between blades 34 and the vanes 42, at a forward end of the fan cowl 170 in the axial direction A. The fan exhaust nozzle 178 is positioned at an aft end of the fan cowl 170 in the axial direction A. In the embodiment depicted, the fan exhaust nozzle 178 is formed annularly around the centerline (CL) between an inner surface of the fan cowl 170 and an outer surface of the core cowl 122. As explained above with respect to FIG. 12, the fan exhaust nozzle 178 is an exhaust for the fan duct 172 that may form at least a portion of the third stream of the unducted fan propulsor 38. Further, the turbomachine exhaust nozzle 140 is positioned at an aft end of core cowl 122 in the axial direction A.

The wing 18 defines a lower surface 3300 on a lower side of the wing 18 with respect to the radial direction R of the gas turbine engine 100, and the upper surface 226 on an upper side of the wing 18 with respect to the radial direction R of the unducted propulsor 38. As shown in FIG. 33, the wing 18 further defines a leading edge 3002 on a forward side of the wing 18 (the leading edge 3002 is positioned at a stagnation point when the aircraft including the wing 18 is operated in a cruise operating condition) with respect to the axial direction A of the unducted fan propulsor 38 and the wing 18 further defines a trailing edge (not shown) on an aft side of the wing 18 with respect to the axial direction A of the unducted fan propulsor 38. The unducted fan propulsor 38 is attached to the wing 18 via a pylon fairing 3304, which may be implemented by any of the example pylon fairings disclosed in connection with FIGS. 13-32. In the embodiment depicted, the pylon fairing 3304 extends between the lower surface 3300 of the wing 18, the leading edge 3302 of the wing 18, or both to an upper surface of the unducted fan propulsor 38. More specifically, for the embodiment depicted, the pylon fairing 3304 is attached to an upper surface of the fan cowl 170, the core cowl 122, or both. Although not shown, according to one or more embodiments, the pylon fairing 3304 may extend to the aft end 116 of the unducted fan propulsor 38.

It will be appreciated, however, that the configuration depicted in FIG. 33 is by way of example only. In other exemplary embodiments of the present disclosure, the pylon fairing 3304 may be oriented in any suitable manner relative to the wing 18 and/or the unducted fan propulsor 38. For example, in certain exemplary embodiments, the pylon fairing 3304 may be oriented perpendicularly to the wing 18, may be oriented perpendicularly to a plane parallel to the ground when installed, etc.

As shown in FIG. 33, the gully distance g is formed between the wing 18 and the unducted fan propulsor 38, and more specifically for the embodiment show is defined as the minimum distance between the wing 18 and the unducted fan propulsor 38. More specifically, still, for the embodiment depicted the gully distance g is the minimum distance between the unducted fan propulsor 38, as measured from the lower surface 3300 of the wing 18 (e.g., a surface below the leading edge 3002) to a first point 3306a on an upper surface of the fan cowl 170 directly adjacent to the pylon fairing 3304 with respect to the circumferential direction C of the unducted fan propulsor 38. The gully distance g is defined within a reference plane 3308, the reference plane 3308 extending perpendicular to the axial direction A and positioned at an axial position 3310.

At the corresponding axial position 3310 of the gully distance g, unducted fan propulsor 38 defines a first distance d1 that is a distance from the centerline (CL) to an upper outer surface portion of the fan cowl 170 (i.e., an upper half of the outer surface of the fan cowl 170 in a normal operational attitude), and more specifically to a first point 3306a on an outermost surface of the unducted fan propulsor 38 on an upper side of the unducted fan propulsor 38 at a position directly axially adjacent to the pylon fairing 3304, as shown in FIG. 34. At the axial position 3310 of the gully distance g, the unducted fan propulsor 38 further defines a second distance d2 that is a distance from the centerline (CL) to a lower outer surface portion of the fan cowl 170 (i.e., a lower half of the outer surface of the fan cowl 170 in a normal operational attitude), and more specifically to a second point 3306b on an outermost surface of the unducted fan propulsor 38 on a lower side of the unducted fan propulsor 38, as shown in FIG. 34. The first point 3306a, the centerline (CL), and the second point 3306b are colinear (i.e., a straight line passes through all three). As shown in FIG. 34, at the axial position 3310 of the gully distance g, the distance measured radially from the centerline (CL) to the outer surface of the unducted fan propulsor 38 is maximum at the lowermost portion of the unducted fan propulsor 38, and continually decreases in the upper direction until the minimum is reached at the uppermost portion of the unducted fan propulsor 38, adjacent to the pylon fairing 3304.

As shown in FIG. 34, gully areas 3400 are formed between the wing 18 and the unducted fan propulsor 38 adjacent to the pylon fairing 3304. The fan exhaust nozzle 178, which may be an exit of a third stream flowpath according to one or more embodiments, narrows from a lower end of the unducted fan propulsor 38 in the radial direction R to an upper end of the unducted fan propulsor 38 in the radial direction R, such that the upper portion of the fan exhaust nozzle 178 is significantly narrower than the lower portion of the fan exhaust nozzle 178. As a result, the first distance d1 is less than the second distance d2.

Conventional turbofan engines extend symmetrically around a longitudinal axis. That is, for any given position in an axial direction, the outer surface of a conventional gas turbine engine is disposed at an equal distance in the radial direction from the longitudinal axis. As explained above, the first distance d1 is less than the second distance d2. For a given gully distance g between the centerline (CL) and the lower surface 3300 of the wing 18, decreasing the first distance d1 results in an increase in the gully distance g. Thus, it will be appreciated that, by structuring the gas turbine engine such that the first distance d1 is less than the second distance d2, the gully distance g is increased compared with a conventional gas turbine engine in which the radius of the outer surface is annularly constant.

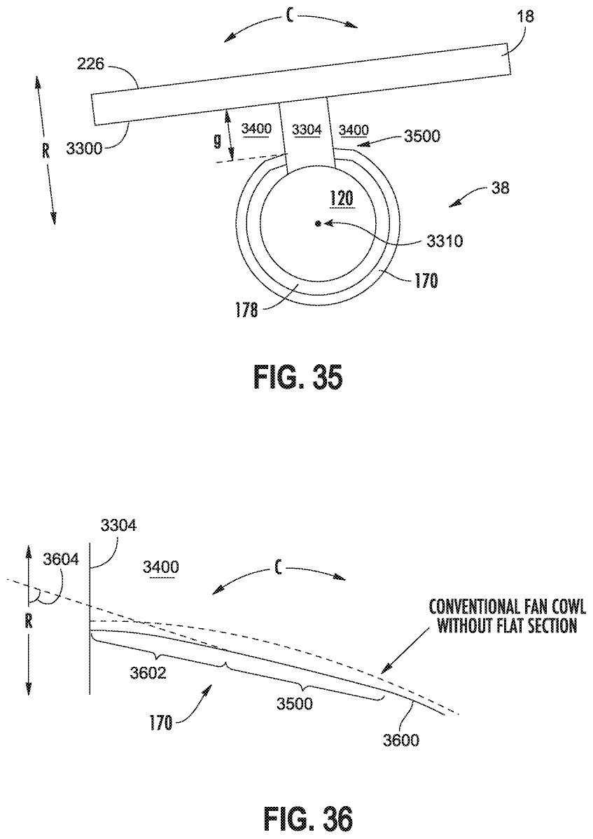

FIG. 35 is a schematic cross-sectional aft view of an unducted fan propulsor 38 attached to a wing 18 according to one or more embodiments of the present disclosure, and FIG. 36 is an explanatory view of a flat section 3500 of the fan nacelle to the right of the pylon fairing 320 in FIG. 35 compared with a conventional fan nacelle. Specifically, FIG. 35 shows a cross-sectional view of the unducted fan propulsor 38 attached to the wing 18 at a reference plane 3308 at an axial position 3310 in which a gully distance g is defined, similar to the reference plane 3308 and axial position 3310 of FIG. 33. Description of the portions similar to FIG. 34 will be omitted.

The unducted fan propulsor 38 shown in FIG. 35 includes a flat section 3500 at an upper portion of the unducted fan propulsor 38 near the pylon fairing 320. In the embodiment depicted, the fan cowl 170 includes symmetrical sections 3600 (FIG. 36) that are annularly symmetrical around the unducted fan propulsor 38, with the fan exhaust nozzle 178 correspondingly annularly symmetrical within the symmetrical sections 3600 of the fan cowl 170. Additionally, the fan cowl 170 further includes curved sections 3602 (FIG. 36) immediately adjacent to the pylon fairing 3304. The fan cowl 170 further includes, between the curved sections 3602 and the symmetrical section 3600, flat sections 3500 (FIG. 36) that are substantially flat.

The flat sections 410 allow for the upper surface of the fan cowl 170 to be farther away from the lower surface 3300 of the wing 18 compared to a gas turbine engine without a flat section, as shown in FIG. 36. Therefore, the fan cowl 170 having the flat section 3500 results in an increase in the gully distance g between the unducted fan propulsor 38 and the lower surface 3300 compared to the conventional fan cowl. While FIG. 36 shows embodiments in which the flat section 3500 extends from a curved section 3602 that extends from the pylon fairing 3304, in alternate embodiments, the flat section 3500 may extend directly from the pylon fairing 3304 to the symmetrical section 3600. Furthermore, while FIG. 36 shows embodiments in which the flat section 3500 extends to the symmetrical section 3600, in alternate embodiments, a transition section may be disposed between the flat section 3500 and the symmetrical section 3600.

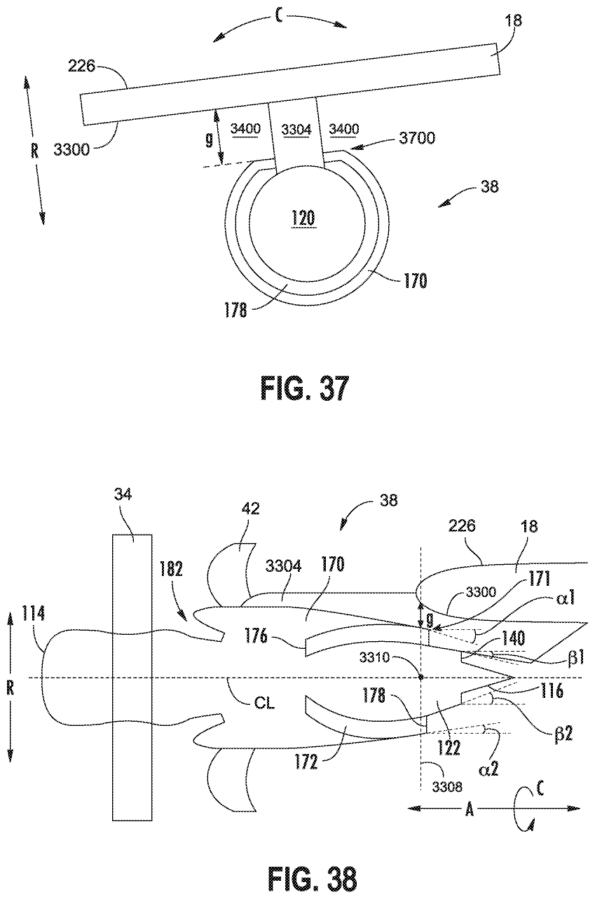

FIG. 37 is a schematic cross-sectional aft view of an unducted fan propulsor 38 attached to a wing 18 according to one or more embodiments of the present disclosure. The embodiment shown in FIG. 37 is similar to FIG. 36, and the description of the portions similar to FIG. 36 will be omitted. While the flat sections 3500 of the unducted fan propulsor 38 shown in FIG. 36 are at an angle with respect to the lower surface 3300 of the wing 18 (and in particular, the flat sections 3500 each define an acute angle 3604 with the radial direction R; see FIG. 36), in the embodiment shown in FIG. 37, the unducted fan propulsor 38 includes a flat portion 3700 that is substantially parallel to the lower surface 3300 of the wing 18, which further increases the gully distance g between the unducted fan propulsor 38 and the lower surface 311 of the wing 18.

FIG. 38 is a schematic side view of an unducted fan propulsor 38 attached to a wing 18 in accordance with one or more embodiments of the present disclosure. The embodiment shown in FIG. 38 is similar to FIG. 33, and description of the portions similar to FIG. 33 will be omitted. The unducted fan propulsor 38 shown in FIG. 38 has a fan cowl 170 (which can also be referred to as a nacelle) and a core cowl 122 that that are both, at least in part, annularly non-symmetrical about the centerline (CL). In the embodiment depicted, only a portion of the core cowl 122 proximate the axial position 3310 of the gully distance g is annularly non-symmetrical about the centerline (CL). The fan duct inlet 176 is annularly symmetrical about the centerline (CL). However, in other exemplary embodiments, at least a portion of the fan duct 172 aft of the fan duct inlet 176 is annularly non-symmetrical.

As shown in FIG. 38, a trailing edge 171 of the fan cowl 170 forms, on an upper end of the unducted fan propulsor 38 in the radial direction R, a first fan cowl angle α1 with respect to the axial direction A, and on a lower end of the unducted fan propulsor 38 in the radial direction R, a second fan cowl angle α2 with respect to the axial direction A. Further, a trailing edge of the core cowl 122 forms, on an upper end of the unducted fan propulsor 38 in the radial direction R, a first core cowl angle β1 with respect to the axial direction A, and on a lower end of the unducted fan propulsor 38 in the radial direction R, a second core cowl angle β2 with respect to the axial direction A. In the embodiment depicted, the first fan cowl angle α1 is greater than the second fan cowl angle α2. More specifically, for the embodiment depicted, the first fan cowl angle α1 is greater than the second fan cowl angle α2, and the second core cowl angle β2 is greater than the first core cowl engine β1. Due to the first fan cowl angle α1 and the second core cowl angle β2 being greater than the second fan cowl angle α2 and the first core cowl angle β1, respectively, the first distance d1 is less than the second distance d2 (see FIG. 34).

Returning to FIG. 38, according to one or more embodiments, the first fan cowl angle α1 is between 1.1 and 3 times the second fan cowl angle α2. For example, in at least certain exemplary embodiments, the first fan cowl angle α1 is between 1.1 and 1.5 times the second fan cowl angle α2, between 1.5 and 2.0 times the second fan cowl angle α2, between 2.0 and 2.5 times the second fan cowl angle α2, or between 2.5 and 3.0 times the second fan cowl angle α2.

According to one or more embodiments, the second core cowl angle β2 is between 1.1 and 3 times the first core cowl angle β1. For example, in at least certain exemplary embodiments, the second core cowl angle β2 is between 1.1 and 1.5 times the first nacelle angle β1, between 1.5 and 2.0 times the first core cowl angle β1, between 2.0 and 2.5 times the first core cowl angle β1, or between 2.5 and 3.0 times the first core cowl angle β1.

According to one or more embodiments, the first distance d1 may be between 80% and 99% of second distance d2. For example, in at least certain exemplary embodiments, the first distance d1 may be between 80 and 85% of the second distance d2, between 85% and 90% of the second distance d2, between 90% and 95% of the second distance d2, or between 95% and 99% of the second distance d2.

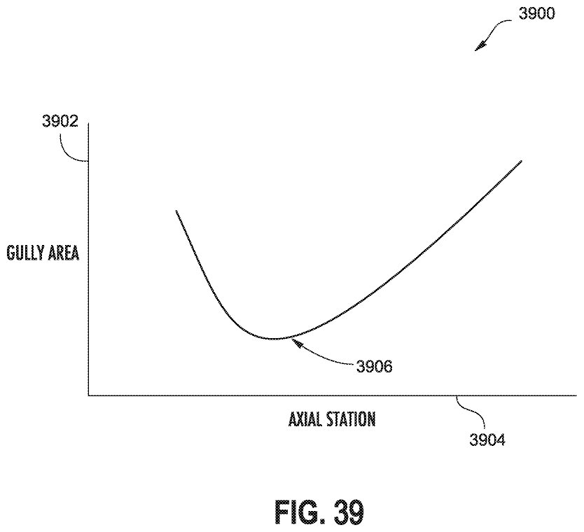

For a given distance between the centerline (CL) and the lower surface 3300 of the wing 18, decreasing the first distance d1 results in an increase in increase d2. Thus, it will be appreciated that, by structuring the gas turbine engine such that the first distance d1 is less than the second distance d2, the gully distance g is increased compared with a conventional gas turbine engine in which the radius of the outer surface is annularly constant. Further, still, referring briefly to the chart 3900 of FIG. 39, a graphical representation of gully area for a given axial station of the gas turbine engine is shown. The axial station may generally increase with a direction of flow of the gas turbine engine and may be aligned with an axial direction of the gas turbine engine. The gully area is shown on a y-axis 3902, and the axial station is shown on an x-axis 3904. A minimum gully area is represented at 3906 and may act as a throat area. The axial station of the minimum gully area 3906 may align with the cross-sectional views depicted in, e.g., FIGS. 35 and 37. Accordingly, increasing the gully distance g in these embodiments may represent an increase in the minimum gully area represented at 3906. The increase in the minimum gully area represented at 3906 can reduce an acceleration at a throat of the gully area, in turn reducing a Mach number of an airflow through the gully area. This may result in a reduced drag at a lower surface of a wing, a side surface of a pylon fairing, and an upper surface of the gas turbine engine, reduce the shock at the gully area, and improve efficiency of the aircraft.

One or more of the above structures of the unducted fan propulsor 38 are applicable to both conventional and counter-rotating open fan configurations. And one or more of the above structures of the unducted fan propulsor 38 are applicable to pylon fairings that are perpendicular to the wing 18 or perpendicular to the ground.

Further aspects of the disclosure are provided by the subject matter of the following clauses:
Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.
Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and θ is between 187° and 340°, and wherein RL/D and θ of the P of the unducted fan propulsor adhere to the following expressions:

$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{R L}{D} + \frac{( \begin{matrix}- \sqrt{\begin{matrix}1.4161 * [ 1.88978 * {sin}^{2} ( θ ) - 0.08 \; 75 * \\ {cos}^{2} ( θ ) + 0.477 * sin ( θ ) * cos ( θ ) ]\end{matrix} +} \\ 1.764 * sin ( θ ) + 0.19146 * cos ( θ )\end{matrix} )}{1.96 * {sin}^{2} ( θ ) + 0.7225 * {cos}^{2} ( θ )} < 0.$$

In the preceding clause, 0.254<RL/D<1.86 and θ is between 199° and 306°, and the P of the unducted fan propulsor is defined by the following expressions:

$$\frac{R L}{D} + \frac{( \begin{matrix}\sqrt{\begin{matrix}0.52621 * [ 0.7205 * {sin}^{2} ( θ ) - 0.3 \; 52 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}0.52621 * [ 0.7205 * {sin}^{2} ( θ ) - 0.3 \; 52 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

In any of the two preceding clauses, 0.369<RL/D<1.43 and θ is between 204° and 291°, and the P of the unducted fan propulsor is defined by the following expressions:

$$\frac{R L}{D} + \frac{( \begin{matrix}\sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}0.52621 * [ 0.7205 * {sin}^{2} ( θ ) - 0.3 \; 52 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

In any of the three preceding clauses: 0.477<RL/D<0.9455 and θ is between 211° and 274°, and the P of the unducted fan propulsor is defined by the following expressions:

$$\frac{R L}{D} + \frac{( \begin{matrix}\sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} \\ 0.139167 * sin ( θ ) + 0.020812 * cos ( θ )\end{matrix} + )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} < 0.$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.
Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein θ is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.
Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.
Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.
Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and θ is between 187° and 340°; and wherein RL/D and θ of the P of the unducted fan propulsor adhere to the following expressions:

$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{R L}{D} + \frac{( \begin{matrix}- \sqrt{\begin{matrix}1.4161 * [ 1.88978 * {sin}^{2} ( θ ) - 0.08 \; 75 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} < 0.$$

The aircraft of Clause 6, wherein:
0.254<RL/D<1.86 and θ is between 199° and 306°, and
the P of the unducted fan propulsor is defined by the following expressions:

$$\frac{R L}{D} + \frac{( \begin{matrix}\sqrt{\begin{matrix}0.52621 * [ 0.7205 * {sin}^{2} ( θ ) - 0.3 \; 52 * \\ {cos}^{2} ( θ ) + 0.7448 * sin ( θ ) * cos ( θ ) ]\end{matrix}} + \\ 0.8476 * sin ( θ ) + 023119 * cos ( θ )\end{matrix} )}{0.8649 * {sin}^{2} ( θ ) + 0.6084 * {cos}^{2} ( θ )} > 0$$

$$and$$

$$\frac{R L}{D} + \frac{( \begin{matrix}- \sqrt{\begin{matrix}0.52621 * [ 0.7205 * {sin}^{2} ( θ ) - 0.3 \; 52 * \\ {cos}^{2} ( θ ) + 0.7448 * sin ( θ ) * cos ( θ ) ]\end{matrix}} + \\ 0.8476 * sin ( θ ) + 0.23119 * cos ( θ )\end{matrix} )}{0.8649 * {sin}^{2} ( θ ) + 0.6084 * {cos}^{2} ( θ )} < 0.$$

The aircraft of Clause 6, wherein:
0.369<RL/D<1.43 and θ is between 204° and 291°, and
the P of the unducted fan propulsor is defined by the following expressions:

$$\frac{R L}{D} + \frac{( \begin{matrix}\sqrt{\begin{matrix}0.09923 * [ 0.2964 * {sin}^{2} ( θ ) - 0.36 * \\ {cos}^{2} ( θ ) + 0.66 * sin ( θ ) * cos ( θ ) ]\end{matrix}} + \\ 0.3675 * sin ( θ ) + 0.0891 * cos ( θ )\end{matrix} )}{0.49 * {sin}^{2} ( θ ) + 0.2025 * {cos}^{2} ( θ )} > 0$$

$$and$$

$$\frac{R L}{D} + \frac{( \begin{matrix}- \sqrt{\begin{matrix}0.09923 * [ 0.2964 * {sin}^{2} ( θ ) - 0.36 * \\ {cos}^{2} ( θ ) + 0.66 * sin ( θ ) * cos ( θ ) ]\end{matrix}} + \\ 0.3675 * sin ( θ ) + 0.0891 * cos ( θ )\end{matrix} )}{0.49 * {sin}^{2} ( θ ) + 02025 * {cos}^{2} ( θ )} < 0.$$

The aircraft of Clause 6, wherein:
0.477<RL/D<0.9455 and θ is between 211° and 274°, and
the P of the unducted fan propulsor is defined by the following expressions:

$$\frac{R L}{D} + \frac{( \begin{matrix}\sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} + \\ 0.139167 * sin ( θ ) + 0.020812 * cos ( θ )\end{matrix} )}{0.2209 * {sin}^{2} ( θ ) + 0.0484 * {cos}^{2} ( θ )} > 0$$

$$and$$

$$\frac{R L}{D} + \frac{( \begin{matrix}- \sqrt{\begin{matrix}0.01069156 * [ 0.036 * {sin}^{2} ( θ ) - 0.3485 * \\ {cos}^{2} ( θ ) + 0.5418 * sin ( θ ) * cos ( θ ) ]\end{matrix}} \\ 0.139167 * sin ( θ ) + 0.020812 * cos ( θ )\end{matrix} + )}{0.2209 * {sin}^{2} ( θ ) + 0.0484 * {cos}^{2} ( θ )} < 0.$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.
Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein θ is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.
Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07≤RL/D≤2.0 and θ is between 187° and 342.°.

The method of Clause 8, wherein 0.15≤RL/D.

The method of Clause 8, wherein 0.35≤RL/D, and preferably RL/D is about 0.72.

The method of Clause 8, wherein θ is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{net}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.
Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.
Clause 10: An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.
Clause 11: An aircraft comprising: a fuselage; a pair of horizontal stabilizers extending relative to the fuselage, two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07≤RL/D≤2.0 and θ is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to delivers torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, high pressure turbine and power turbine.

In any of the preceding clauses, the propulsor having a pitch angle between −5 and +5 degrees, or −3 and θ degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.
Clause 12: An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; and a pylon fairing to mount each of the unducted fan propulsors to one of the wings.

The aircraft of any preceding clause, wherein 0.15≤RL/D.

The aircraft of any preceding clause, wherein 0.35≤RL/D, and preferably RL/D is about 0.72.

The aircraft of any preceding clause, wherein θ is between 198° and 310°, and preferably between 205° and 285°.

The aircraft of any preceding clause, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85

The aircraft of any preceding clause, wherein the unducted fan propulsor has a dimensionless cruise fan net thrust parameter expressed as follows:

$$0.15 > \frac{{F}_{n e t}}{{ρ}_{0} {A}_{a n} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of any preceding clause, wherein the P of the unducted fan propulsor is variable to accommodate different operating conditions.

The aircraft of any preceding clause, wherein the pylon fairing defines a pylon fairing dihedral.

The aircraft of any preceding clause, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.

The aircraft of any preceding clause, and wherein the pylon fairing dihedral is in a direction opposite the sheared profile of the fan wakes upon arrival at the pylon fairing leading edge.

The aircraft of any preceding clause, wherein the pylon fairing dihedral is at the pylon fairing leading edge.

The aircraft of any preceding clause, wherein the pylon fairing dihedral extends an entirety of the length of the pylon fairing leading edge.

The aircraft of any preceding clause, wherein the pylon fairing includes a pylon fairing body downstream of the pylon fairing leading edge.

The aircraft of any preceding clause, wherein the pylon fairing body downstream of the pylon fairing leading edge is radially aligned.

The aircraft of any preceding clause, wherein the blades of the forward array rotate in a first direction, and wherein the pylon fairing dihedral is in the first direction from a base to a top, and wherein the sheared profiles of fan wakes are leaned in a second direction opposite the first direction from a root to a tip.

The aircraft of any preceding clause, wherein pylon fairing defines a lengthwise direction and comprising a leading edge section, the leading edge section defining a leading edge camber that varies along the lengthwise direction of the pylon fairing.

The aircraft of any preceding clause, wherein the leading edge camber decreases from the root to a tip of a blade of the forward array.

The aircraft of any preceding clause, wherein the leading edge camber is a maximum at the root of the blade of the forward array.

The aircraft of any preceding clause, wherein the leading edge camber is a minimum at the tip of the blade of the forward array.

The aircraft of any preceding clause, wherein the leading edge section defines a leading edge angle that is defined as an angle between the leading edge camber and a tangent line of a pierce point of the pylon fairing.

The aircraft of any preceding clause, wherein the leading edge angle is between approximately 5 degrees and approximately 60 degrees.

The aircraft of any preceding clause, wherein the leading edge angle is between approximately 10 degrees and approximately 50 degrees.

The aircraft of any preceding clause, wherein the leading edge angle is between approximately 15 degrees and approximately 45 degrees.

The aircraft of any preceding clause, wherein the pierce point is a forwardmost point of the pylon fairing.

The aircraft of any preceding clause, wherein the pylon fairing defines a lengthwise direction, a leading edge, a trailing edge, and a chord extending from the leading edge to the trailing edge, the pylon fairing including a maximum thickness portion along the lengthwise direction of the pylon fairing located between 10% and 60% of the chord.

The aircraft of any preceding clause, wherein the maximum thickness portion along the lengthwise direction of the pylon fairing is located between 20% and 50% of the chord.

The aircraft of any preceding clause, wherein the maximum thickness portion along the lengthwise direction of the pylon fairing is located between 30% and 40% of the chord.

The aircraft of any preceding clause, wherein the maximum thickness portion is closer to the leading edge proximate the unducted fan propulsor.

The aircraft of any preceding clause, wherein the maximum thickness portion is closer to the trailing edge proximate the wing.

The aircraft of any preceding clause, wherein the pylon fairing defines a lengthwise direction, a leading edge, a trailing edge, a first chord extending from the leading edge to the trailing edge at a first position along the lengthwise direction, and a second chord extending from the leading edge to the trailing edge at a second position along the lengthwise direction, the pylon fairing including a first maximum thickness portion at a first percentage of the first chord and a second maximum thickness portion at a second percentage of the second chord, wherein the first percentage is different than the second percentage.

The aircraft of any preceding clause, wherein the first maximum thickness portion is located between 30% and 60% of the first chord.

The aircraft of any preceding clause, wherein the second maximum thickness portion is located between 10% and 40% of the second chord.

The aircraft of any preceding clause, wherein the first maximum thickness portion is located a first distance from the leading edge, wherein the second maximum thickness portion is located a second distance from the leading edge, and wherein the second distance is less than the first distance.

The aircraft of any preceding clause, wherein the pylon fairing has a first pressure side and a first suction side, the first pressure side of the pylon fairing defining a first shape, and the first suction side of the pylon fairing defining a second shape different than the first shape.

The aircraft of any preceding clause, wherein the pylon fairing defines a lengthwise direction, a leading edge, a trailing edge, and a chord extending from the leading edge to the trailing edge, and wherein the first shape and the second shape are different at a common location along the lengthwise direction of the pylon fairing.

The aircraft of any preceding clause, wherein the pylon fairing defines a leading edge and including a first inflection point along the leading edge, the first inflection point defining a first radius of curvature that is less than 5 times the maximum outer diameter (D) and greater than 0.1 times the maximum outer diameter (D).

The aircraft of any preceding clause, wherein the first inflection point is located at a position closer to the unducted fan propulsor than the wing.

The aircraft of any preceding clause, wherein the pylon fairing includes a cantilevered stator vane.

The aircraft of any preceding clause, wherein the leading edge of the pylon fairing defines a duckbill shape.

The aircraft of any preceding clause, wherein the pylon fairing includes a second inflection point along the leading edge downstream of the first inflection point, the second inflection point defining a second radius of curvature that is less than 3 times the maximum outer diameter (D) and greater than 0.1 times the maximum outer diameter (D).

The aircraft of any preceding clause, wherein the pylon fairing includes a third inflection point along the leading edge downstream of the second inflection point, the third inflection point defining a third radius of curvature that is less than 3 times the maximum outer diameter (D) and greater than 0.1 times the maximum outer diameter (D).

The aircraft of any preceding clause, wherein the pylon fairing has a forwardmost point upstream the rearward trailing edge of a blade of the rearward array.

The aircraft of any preceding clause, wherein the unducted fan propulsor includes a forward compressor frame having a mount, and the forwardmost point of the pylon fairing is upstream of the mount.

The aircraft of any preceding clause, wherein the forwardmost point of the pylon fairing covers the mount of the forward compressor frame.

The aircraft of any preceding clause, wherein the forwardmost point of the pylon fairing extends to an inlet lip of the unducted fan propulsor.

The aircraft of any preceding clause, wherein the pylon fairing includes a rearmost point that extends to a core nozzle exit of the unducted fan propulsor.

The aircraft of any preceding clause, wherein each of the unductor fan propulsors includes a turbomachine; and a fan cowl surrounding the turbomachine and comprising an upper outer surface portion and a lower outer surface portion, the fan cowl defining a first distance extending radially from the centerline to a first point located at the upper outer surface portion, the fan cowl further defining a second distance extending radially from the centerline to a second point located at the lower outer surface portion, and the second distance is greater than the first distance.

The aircraft of any preceding clause, wherein the turbomachine comprises a core cowl, wherein the core cowl is located at least in part downstream from the fan cowl.

The aircraft of any preceding clause, wherein the turbomachine comprises a core cowl, wherein the core cowl is annularly symmetrical about the centerline.

The aircraft of any preceding clause, wherein the turbomachine comprises a core cowl, wherein a trailing edge of the housing defines, at an upper portion of the unducted fan propulsor, a first fan cowl angle with respect to the axial direction, and at a lower portion of the unducted fan propulsor, a second fan cowl angle with respect to the axial direction, wherein a trailing edge of the core cowl defines, at the upper portion of the unducted fan propulsor, a first core cowl angle with respect to the axial direction, and at the lower portion of the unducted fan propulsor, a second core cowl angle with respect to the axial direction, and wherein the second fan cowl angle is different than the first fan cowl angle, and the second core cowl angle is different than the first core cowl angle.

The aircraft of any preceding clause, wherein the turbomachine comprises a core cowl, wherein the unducted fan propulsor defines a third stream flowpath extending between the fan cowl and the core cowl.

The aircraft of any preceding clause, wherein the first and second distances are defined at an axial position, and wherein, at the axial position, the third stream flowpath of the unducted fan propulsor narrows from a lower portion of the unducted fan propulsor in the radial direction to an upper portion of the unducted fan propulsor.

The aircraft of any preceding clause, wherein the unducted fan propulsor defines a reference plane extending perpendicular to the centerline, wherein the first and second distances are defined in the reference plane.

The aircraft of any preceding clause, wherein the first and second distances are defined at an axial position, and wherein the fan cowl comprises, at the axial position, a flat section that is flat within the reference plane.

The aircraft of any preceding clause, wherein the flat section forms an acute angle with the radial direction.

The aircraft of any preceding clause, wherein the wing, the unducted propulsor, and the pylon fairing together defining in part a gully area, wherein the unducted fan propulsor includes a turbomachine and a fan cowl surrounding the turbomachine and comprising an outer surface, the fan cowl defining a first distance between the centerline and a first point on the outer surface of the fan cowl, the fan cowl further defining a second distance between the centerline and a second point on the outer surface of the fan cowl, the first point closer to the gully area than the second point, the first distance and the second distance defined in a reference plane extending perpendicular to the centerline, and the second distance being greater than the first distance.

The aircraft of any preceding clause, wherein the gully area is disposed downstream of the rotating blades.

The aircraft of any preceding clause, wherein the first and second distances are defined at an axial position, and wherein the axial position is defined at an axial location having a minimum distance in the radial direction between the wing and the unducted fan propulsor.

The aircraft of any preceding clause, wherein the turbomachine comprises a core cowl.

The aircraft of any preceding clause, wherein the core cowl is annularly symmetrical about the centerline.
Clause 13: An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7; and a pylon fairing to mount the unducted fan propulsor to the airfoil.

The aircraft of any preceding clause, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The aircraft of any preceding clause, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The aircraft of any preceding clause, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

The aircraft of any preceding clause, wherein the pylon fairing defines a pylon fairing dihedral.

The aircraft of any preceding clause, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.

The aircraft of any preceding clause, and wherein the pylon fairing dihedral is in a direction opposite the sheared profile of the fan wakes upon arrival at the pylon fairing leading edge.

The aircraft of any preceding clause, wherein the pylon fairing dihedral is at the pylon fairing leading edge.

The aircraft of any preceding clause, wherein the pylon fairing dihedral extends an entirety of the length of the pylon fairing leading edge.

The aircraft of any preceding clause, wherein the pylon fairing includes a pylon fairing body downstream of the pylon fairing leading edge.

The aircraft of any preceding clause, wherein the pylon fairing body downstream of the pylon fairing leading edge is radially aligned.

The aircraft of any preceding clause, wherein the blades of the forward array rotate in a first direction, and wherein the pylon fairing dihedral is in the first direction from a base to a top, and wherein the sheared profiles of fan wakes are leaned in a second direction opposite the first direction from a root to a tip.

The aircraft of any preceding clause, wherein pylon fairing defines a lengthwise direction and comprising a leading edge section, the leading edge section defining a leading edge camber that varies along the lengthwise direction of the pylon fairing.

The aircraft of any preceding clause, wherein the leading edge camber decreases from the root to a tip of a blade of the forward array.

The aircraft of any preceding clause, wherein the leading edge camber is a maximum at the root of the blade of the forward array.

The aircraft of any preceding clause, wherein the leading edge camber is a minimum at the tip of the blade of the forward array.

The aircraft of any preceding clause, wherein the leading edge section defines a leading edge angle that is defined as an angle between the leading edge camber and a tangent line of a pierce point of the pylon fairing.

The aircraft of any preceding clause, wherein the leading edge angle is between approximately 5 degrees and approximately 60 degrees.

The aircraft of any preceding clause, wherein the leading edge angle is between approximately 10 degrees and approximately 50 degrees.

The aircraft of any preceding clause, wherein the leading edge angle is between approximately 15 degrees and approximately 45 degrees.

The aircraft of any preceding clause, wherein the pierce point is a forwardmost point of the pylon fairing.

The aircraft of any preceding clause, wherein the pylon fairing defines a lengthwise direction, a leading edge, a trailing edge, and a chord extending from the leading edge to the trailing edge, the pylon fairing including a maximum thickness portion along the lengthwise direction of the pylon fairing located between 10% and 60% of the chord.

The aircraft of any preceding clause, wherein the maximum thickness portion along the lengthwise direction of the pylon fairing is located between 20% and 50% of the chord.

The aircraft of any preceding clause, wherein the maximum thickness portion along the lengthwise direction of the pylon fairing is located between 30% and 40% of the chord.

The aircraft of any preceding clause, wherein the maximum thickness portion is closer to the leading edge proximate the unducted fan propulsor.

The aircraft of any preceding clause, wherein the maximum thickness portion is closer to the trailing edge proximate the airfoil.

The aircraft of any preceding clause, wherein the pylon fairing defines a lengthwise direction, a leading edge, a trailing edge, a first chord extending from the leading edge to the trailing edge at a first position along the lengthwise direction, and a second chord extending from the leading edge to the trailing edge at a second position along the lengthwise direction, the pylon fairing including a first maximum thickness portion at a first percentage of the first chord and a second maximum thickness portion at a second percentage of the second chord, wherein the first percentage is different than the second percentage.

The aircraft of any preceding clause, wherein the first maximum thickness portion is located between 30% and 60% of the first chord.

The aircraft of any preceding clause, wherein the second maximum thickness portion is located between 10% and 40% of the second chord.

The aircraft of any preceding clause, wherein the first maximum thickness portion is located a first distance from the leading edge, wherein the second maximum thickness portion is located a second distance from the leading edge, and wherein the second distance is less than the first distance.

The aircraft of any preceding clause, wherein the pylon fairing has a first pressure side and a first suction side, the first pressure side of the pylon fairing defining a first shape, and the first suction side of the pylon fairing defining a second shape different than the first shape.

The aircraft of any preceding clause, wherein the pylon fairing defines a lengthwise direction, a leading edge, a trailing edge, and a chord extending from the leading edge to the trailing edge, and wherein the first shape and the second shape are different at a common location along the lengthwise direction of the pylon fairing.

The aircraft of any preceding clause, wherein the pylon fairing defines a leading edge and including a first inflection point along the leading edge, the first inflection point defining a first radius of curvature that is less than 5 times the maximum outer diameter (D) and greater than 0.1 times the maximum outer diameter (D).

The aircraft of any preceding clause, wherein the first inflection point is located at a position closer to the unducted fan propulsor than the airfoil.

The aircraft of any preceding clause, wherein the pylon fairing includes a cantilevered stator vane.

The aircraft of any preceding clause, wherein the leading edge of the pylon fairing defines a duckbill shape.

The aircraft of any preceding clause, wherein the pylon fairing includes a second inflection point along the leading edge downstream of the first inflection point, the second inflection point defining a second radius of curvature that is less than 3 times the maximum outer diameter (D) and greater than 0.1 times the maximum outer diameter (D).

The aircraft of any preceding clause, wherein the pylon fairing includes a third inflection point along the leading edge downstream of the second inflection point, the third inflection point defining a third radius of curvature that is less than 3 times the maximum outer diameter (D) and greater than 0.1 times the maximum outer diameter (D).

The aircraft of any preceding clause, wherein the pylon fairing has a forwardmost point upstream the rearward trailing edge of a blade of the rearward array.

The aircraft of any preceding clause, wherein the unducted fan propulsor includes a forward compressor frame having a mount, and the forwardmost point of the pylon fairing is upstream of the mount.

The aircraft of any preceding clause, wherein the forwardmost point of the pylon fairing covers the mount of the forward compressor frame.

The aircraft of any preceding clause, wherein the forwardmost point of the pylon fairing extends to an inlet lip of the unducted fan propulsor.

The aircraft of any preceding clause, wherein the pylon fairing includes a rearmost point that extends to a core nozzle exit of the unducted fan propulsor.

The aircraft of any preceding clause, wherein each of the unductor fan propulsors includes a turbomachine; and a fan cowl surrounding the turbomachine and comprising an upper outer surface portion and a lower outer surface portion, the fan cowl defining a first distance extending radially from the centerline to a first point located at the upper outer surface portion, the fan cowl further defining a second distance extending radially from the centerline to a second point located at the lower outer surface portion, and the second distance is greater than the first distance.

The aircraft of any preceding clause, wherein the turbomachine comprises a core cowl, wherein the core cowl is located at least in part downstream from the fan cowl.

The aircraft of any preceding clause, wherein the turbomachine comprises a core cowl, wherein the core cowl is annularly symmetrical about the centerline.

The aircraft of any preceding clause, wherein the turbomachine comprises a core cowl, wherein a trailing edge of the housing defines, at an upper portion of the unducted fan propulsor, a first fan cowl angle with respect to the axial direction, and at a lower portion of the unducted fan propulsor, a second fan cowl angle with respect to the axial direction, wherein a trailing edge of the core cowl defines, at the upper portion of the unducted fan propulsor, a first core cowl angle with respect to the axial direction, and at the lower portion of the unducted fan propulsor, a second core cowl angle with respect to the axial direction, and wherein the second fan cowl angle is different than the first fan cowl angle, and the second core cowl angle is different than the first core cowl angle.

The aircraft of any preceding clause, wherein the turbomachine comprises a core cowl, wherein the unducted fan propulsor defines a third stream flowpath extending between the fan cowl and the core cowl.

The aircraft of any preceding clause, wherein the first and second distances are defined at an axial position, and wherein, at the axial position, the third stream flowpath of the unducted fan propulsor narrows from a lower portion of the unducted fan propulsor in the radial direction to an upper portion of the unducted fan propulsor.

The aircraft of any preceding clause, wherein the unducted fan propulsor defines a reference plane extending perpendicular to the centerline, wherein the first and second distances are defined in the reference plane.

The aircraft of any preceding clause, wherein the first and second distances are defined at an axial position, and wherein the fan cowl comprises, at the axial position, a flat section that is flat within the reference plane.

The aircraft of any preceding clause, wherein the flat section forms an acute angle with the radial direction.

The aircraft of any preceding clause, wherein the airfoil, the unducted propulsor, and the pylon fairing together defining in part a gully area, wherein the unducted fan propulsor includes a turbomachine and a fan cowl surrounding the turbomachine and comprising an outer surface, the fan cowl defining a first distance between the centerline and a first point on the outer surface of the fan cowl, the fan cowl further defining a second distance between the centerline and a second point on the outer surface of the fan cowl, the first point closer to the gully area than the second point, the first distance and the second distance defined in a reference plane extending perpendicular to the centerline, and the second distance being greater than the first distance.

The aircraft of any preceding clause, wherein the gully area is disposed downstream of the rotating blades.

The aircraft of any preceding clause, wherein the first and second distances are defined at an axial position, and wherein the axial position is defined at an axial location having a minimum distance in the radial direction between the airfoil and the unducted fan propulsor.

The aircraft of any preceding clause, wherein the turbomachine comprises a core cowl.

The aircraft of any preceding clause, wherein the core cowl is annularly symmetrical about the centerline.
Clause 14: An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} > 0$$

$$and$$

$$\frac{R L}{D} + \frac{( - \begin{matrix}\sqrt{\begin{matrix}1.4161 * [ 1.88978 * {sin}^{2} ( θ ) - 0.08 \; 75 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} < 0 ;$$

and
a pylon fairing to mount the unducted fan propulsor to the airfoil, the pylon fairing defining a pylon fairing dihedral.

The aircraft of any preceding clause, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.

The aircraft of any preceding clause, wherein the pylon fairing defines a pylon fairing dihedral.

The aircraft of any preceding clause, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.

The aircraft of any preceding clause, and wherein the pylon fairing dihedral is in a direction opposite the sheared profile of the fan wakes upon arrival at the pylon fairing leading edge.

The aircraft of any preceding clause, wherein the pylon fairing dihedral is at the pylon fairing leading edge.

The aircraft of any preceding clause, wherein the pylon fairing dihedral extends an entirety of the length of the pylon fairing leading edge.

The aircraft of any preceding clause, wherein the pylon fairing includes a pylon fairing body downstream of the pylon fairing leading edge.

The aircraft of any preceding clause, wherein the pylon fairing body downstream of the pylon fairing leading edge is radially aligned.

The aircraft of any preceding clause, wherein the blades of the forward array rotate in a first direction, and wherein the pylon fairing dihedral is in the first direction from a base to a top, and wherein the sheared profiles of fan wakes are leaned in a second direction opposite the first direction from a root to a tip.

The aircraft of any preceding clause, wherein pylon fairing defines a lengthwise direction and comprising a leading edge section, the leading edge section defining a leading edge camber that varies along the lengthwise direction of the pylon fairing.

The aircraft of any preceding clause, wherein the leading edge camber decreases from the root to a tip of a blade of the forward array.

The aircraft of any preceding clause, wherein the leading edge camber is a maximum at the root of the blade of the forward array.

The aircraft of any preceding clause, wherein the leading edge camber is a minimum at the tip of the blade of the forward array.

The aircraft of any preceding clause, wherein the leading edge section defines a leading edge angle that is defined as an angle between the leading edge camber and a tangent line of a pierce point of the pylon fairing.

The aircraft of any preceding clause, wherein the leading edge angle is between approximately 5 degrees and approximately 60 degrees.

The aircraft of any preceding clause, wherein the leading edge angle is between approximately 10 degrees and approximately 50 degrees.

The aircraft of any preceding clause, wherein the leading edge angle is between approximately 15 degrees and approximately 45 degrees.

The aircraft of any preceding clause, wherein the pierce point is a forwardmost point of the pylon fairing.

The aircraft of any preceding clause, wherein the pylon fairing defines a lengthwise direction, a leading edge, a trailing edge, and a chord extending from the leading edge to the trailing edge, the pylon fairing including a maximum thickness portion along the lengthwise direction of the pylon fairing located between 10% and 60% of the chord.

The aircraft of any preceding clause, wherein the maximum thickness portion along the lengthwise direction of the pylon fairing is located between 20% and 50% of the chord.

The aircraft of any preceding clause, wherein the maximum thickness portion along the lengthwise direction of the pylon fairing is located between 30% and 40% of the chord.

The aircraft of any preceding clause, wherein the maximum thickness portion is closer to the leading edge proximate the unducted fan propulsor.

The aircraft of any preceding clause, wherein the maximum thickness portion is closer to the trailing edge proximate the airfoil.

The aircraft of any preceding clause, wherein the pylon fairing defines a lengthwise direction, a leading edge, a trailing edge, a first chord extending from the leading edge to the trailing edge at a first position along the lengthwise direction, and a second chord extending from the leading edge to the trailing edge at a second position along the lengthwise direction, the pylon fairing including a first maximum thickness portion at a first percentage of the first chord and a second maximum thickness portion at a second percentage of the second chord, wherein the first percentage is different than the second percentage.

The aircraft of any preceding clause, wherein the first maximum thickness portion is located between 30% and 60% of the first chord.

The aircraft of any preceding clause, wherein the second maximum thickness portion is located between 10% and 40% of the second chord.

The aircraft of any preceding clause, wherein the first maximum thickness portion is located a first distance from the leading edge, wherein the second maximum thickness portion is located a second distance from the leading edge, and wherein the second distance is less than the first distance.

The aircraft of any preceding clause, wherein the pylon fairing has a first pressure side and a first suction side, the first pressure side of the pylon fairing defining a first shape, and the first suction side of the pylon fairing defining a second shape different than the first shape.

The aircraft of any preceding clause, wherein the pylon fairing defines a lengthwise direction, a leading edge, a trailing edge, and a chord extending from the leading edge to the trailing edge, and wherein the first shape and the second shape are different at a common location along the lengthwise direction of the pylon fairing.

The aircraft of any preceding clause, wherein the pylon fairing defines a leading edge and including a first inflection point along the leading edge, the first inflection point defining a first radius of curvature that is less than 5 times the maximum outer diameter (D) and greater than 0.1 times the maximum outer diameter (D).

The aircraft of any preceding clause, wherein the first inflection point is located at a position closer to the unducted fan propulsor than the airfoil.

The aircraft of any preceding clause, wherein the pylon fairing includes a cantilevered stator vane.

The aircraft of any preceding clause, wherein the leading edge of the pylon fairing defines a duckbill shape.

The aircraft of any preceding clause, wherein the pylon fairing includes a second inflection point along the leading edge downstream of the first inflection point, the second inflection point defining a second radius of curvature that is less than 3 times the maximum outer diameter (D) and greater than 0.1 times the maximum outer diameter (D).

The aircraft of any preceding clause, wherein the pylon fairing includes a third inflection point along the leading edge downstream of the second inflection point, the third inflection point defining a third radius of curvature that is less than 3 times the maximum outer diameter (D) and greater than 0.1 times the maximum outer diameter (D).

The aircraft of any preceding clause, wherein the pylon fairing has a forwardmost point upstream the rearward trailing edge of a blade of the rearward array.

The aircraft of any preceding clause, wherein the unducted fan propulsor includes a forward compressor frame having a mount, and the forwardmost point of the pylon fairing is upstream of the mount.

The aircraft of any preceding clause, wherein the forwardmost point of the pylon fairing covers the mount of the forward compressor frame.

The aircraft of any preceding clause, wherein the forwardmost point of the pylon fairing extends to an inlet lip of the unducted fan propulsor.

The aircraft of any preceding clause, wherein the pylon fairing includes a rearmost point that extends to a core nozzle exit of the unducted fan propulsor.

The aircraft of any preceding clause, wherein each of the unductor fan propulsors includes a turbomachine; and a fan cowl surrounding the turbomachine and comprising an upper outer surface portion and a lower outer surface portion, the fan cowl defining a first distance extending radially from the centerline to a first point located at the upper outer surface portion, the fan cowl further defining a second distance extending radially from the centerline to a second point located at the lower outer surface portion, and the second distance is greater than the first distance.

The aircraft of any preceding clause, wherein the turbomachine comprises a core cowl, wherein the core cowl is located at least in part downstream from the fan cowl.

The aircraft of any preceding clause, wherein the turbomachine comprises a core cowl, wherein the core cowl is annularly symmetrical about the centerline.

The aircraft of any preceding clause, wherein the turbomachine comprises a core cowl, wherein a trailing edge of the housing defines, at an upper portion of the unducted fan propulsor, a first fan cowl angle with respect to the axial direction, and at a lower portion of the unducted fan propulsor, a second fan cowl angle with respect to the axial direction, wherein a trailing edge of the core cowl defines, at the upper portion of the unducted fan propulsor, a first core cowl angle with respect to the axial direction, and at the lower portion of the unducted fan propulsor, a second core cowl angle with respect to the axial direction, and wherein the second fan cowl angle is different than the first fan cowl angle, and the second core cowl angle is different than the first core cowl angle.

The aircraft of any preceding clause, wherein the turbomachine comprises a core cowl, wherein the unducted fan propulsor defines a third stream flowpath extending between the fan cowl and the core cowl.

The aircraft of any preceding clause, wherein the first and second distances are defined at an axial position, and wherein, at the axial position, the third stream flowpath of the unducted fan propulsor narrows from a lower portion of the unducted fan propulsor in the radial direction to an upper portion of the unducted fan propulsor.

The aircraft of any preceding clause, wherein the unducted fan propulsor defines a reference plane extending perpendicular to the centerline, wherein the first and second distances are defined in the reference plane.

The aircraft of any preceding clause, wherein the first and second distances are defined at an axial position, and wherein the fan cowl comprises, at the axial position, a flat section that is flat within the reference plane.

The aircraft of any preceding clause, wherein the flat section forms an acute angle with the radial direction.

The aircraft of any preceding clause, wherein the airfoil, the unducted propulsor, and the pylon fairing together defining in part a gully area, wherein the unducted fan propulsor includes a turbomachine and a fan cowl surrounding the turbomachine and comprising an outer surface, the fan cowl defining a first distance between the centerline and a first point on the outer surface of the fan cowl, the fan cowl further defining a second distance between the centerline and a second point on the outer surface of the fan cowl, the first point closer to the gully area than the second point, the first distance and the second distance defined in a reference plane extending perpendicular to the centerline, and the second distance being greater than the first distance.

The aircraft of any preceding clause, wherein the gully area is disposed downstream of the rotating blades.

The aircraft of any preceding clause, wherein the first and second distances are defined at an axial position, and wherein the axial position is defined at an axial location having a minimum distance in the radial direction between the airfoil and the unducted fan propulsor.

The aircraft of any preceding clause, wherein the turbomachine comprises a core cowl.

The aircraft of any preceding clause, wherein the core cowl is annularly symmetrical about the centerline.

1. An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other;
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; and
a pylon fairing to mount each of the unducted fan propulsors to one of the wings, the pylon fairing defining a pylon fairing dihedral.

2. The aircraft of claim 1, wherein 0.15≤RL/D.

3. The aircraft of claim 1, wherein 0.35≤RL/D, and preferably RL/D is about 0.72.

4. The aircraft of claim 1, wherein θ is between 198° and 310°, and preferably between 205° and 285°.

5. The aircraft of claim 1, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

6. The aircraft of claim 1, wherein the unducted fan propulsor has a dimensionless cruise fan net thrust parameter expressed as follows:
$$0.15 > \frac{{F}_{net}}{{ρ}_{0} {A}_{a n} {V}_{0}^{2}} > 0.06 ,$$
wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

7. The aircraft of claim 1, wherein the P of the unducted fan propulsor is variable to accommodate different operating conditions.

8. The aircraft of claim 1, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.

9. The aircraft of claim 8, and wherein the pylon fairing dihedral is in a direction opposite the sheared profile of the fan wakes upon arrival at the pylon fairing leading edge.

10. The aircraft of claim 8, wherein the pylon fairing dihedral is at the pylon fairing leading edge.

11. The aircraft of claim 10, wherein the pylon fairing dihedral extends an entirety of the length of the pylon fairing leading edge.

12. The aircraft of claim 1, wherein the pylon fairing has a forwardmost point upstream the rearward trailing edge of a blade of the rearward array.

13. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7; and
a pylon fairing to mount the unducted fan propulsor to the airfoil, the pylon fairing defining a pylon fairing dihedral.

14. The aircraft of claim 13, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

15. The aircraft of claim 13, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

16. The aircraft of claim 13, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

17. The aircraft of claim 13, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.

18. The aircraft of claim 17, and wherein the pylon fairing dihedral is in a direction opposite the sheared profile of the fan wakes upon arrival at the pylon fairing leading edge.

19. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other;
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{R L}{D} + \frac{( \begin{matrix}\sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} > 0$$
$$and$$
$$\frac{R L}{D} + \frac{( \begin{matrix}- \sqrt{\begin{matrix}1.4161 * [ 1.88978 * {sin}^{2} ( θ ) - 0.08 \; 75 * \\ {cos}^{2} ( θ ) + 0.477 * sin ( θ ) * cos ( θ ) ]\end{matrix}} + \\ 1.764 * sin ( θ ) + 0.19146 * cos ( θ )\end{matrix} )}{1.96 * {sin}^{2} ( θ ) + 0.7225 * {cos}^{2} ( θ )} < 0 ;$$
and
a pylon fairing to mount the unducted fan propulsor to the airfoil, the pylon fairing defining a pylon fairing dihedral.

20. The aircraft of claim 19, wherein the unducted fan propulsor defines a plurality of fan wakes having a sheared profile during operation of the unducted fan propulsor, wherein the pylon fairing has a pylon fairing leading edge, and wherein the pylon fairing dihedral is configured to increase a phasing or rate of time of the fan wake interactions with the pylon fairing leading edge.
